(19) United States
(12) Patent Application Publication
(10) Pub. No.: US 2007/0274711 A1
(43) Pub. Date: Nov. 29, 2007

(54) SUBSTRATE PROCESSING APPARATUS AND SUBSTRATE PROCESSING METHOD

(76) Inventors: Koji KANEYAMA, Kyoto (JP); Kazuhito SHIGEMORI, Kyoto (JP); Masashi KANAOKA, Kyoto (JP); Tadashi MIYAGI, Kyoto (JP); Shuichi YASUDA, Kyoto (JP)

Correspondence Address: OSTROLENK FABER GERB & SOFFEN, 1180 AVENUE OF THE AMERICAS, NEW YORK, NY, 100368403, US

(21) Appl. No.: 11/754,631

(22) Filed: May 29, 2007

(30) Foreign Application Priority Data
May 29, 2006 (JP) 2006-147911

(51) Int. Cl. G03D 5/00

(52) U.S. Cl. 396/611; 134/18; 134/56 R; 414/222.05

(57) ABSTRACT

A cleaning substrate for use in the cleaning operation for a substrate stage in an exposure unit compatible with immersion exposure and a dummy substrate for use during the adjustment of an exposure position of a pattern image in the exposure unit are held in a cleaning substrate housing part and a dummy substrate housing part, respectively, which are provided in a substrate processing apparatus. For the cleaning operation for the substrate stage or an alignment operation in the exposure unit, the cleaning substrate or the dummy substrate is transferred from the substrate processing apparatus to the exposure unit. A back surface cleaning process on the cleaning substrate or the dummy substrate is performed in a back surface cleaning unit of the substrate processing apparatus immediately before or immediately after the cleaning operation for the substrate stage or the alignment operation.

### BACKGROUND OF THE INVENTION

1. Field of the Invention

The present invention relates to a substrate processing apparatus for performing a resist coating process and a development process on a substrate such as a semiconductor substrate, a glass substrate for a liquid crystal display device, a glass substrate for a photomask, a substrate for an optical disk and the like, the substrate processing apparatus being disposed adjacently to an exposure apparatus for performing an exposure process on the substrate. The present invention also relates to a substrate processing method which uses the substrate processing apparatus.

2. Description of the Background Art

As is well known, semiconductor and liquid crystal display products and the like are fabricated by performing a series of processes including cleaning, resist coating, exposure, development, etching, formation of interlayer insulation film, heat treatment, dicing and the like on the above-discussed substrate. Of these various processes, the exposure process is a process of transferring a pattern on a reticle (a mask for printing) to a resist-coated substrate, and serves as a key part of a so-called photolithography process. Since the pattern is extremely fine, so-called step-and-repeat exposure, rather than single exposure for the entire wafer, is typically performed in such a manner that the wafer is exposed repeatedly in batches of several chips.

On the other hand, with the rapid increase in density of a semiconductor device and the like in recent years, there has been a strong demand to make a mask pattern finer. For this reason, as light sources in an exposure apparatus for performing the exposure process, deep-UV light sources such as a KrF excimer laser light source and an ArF excimer laser light source which emit light of relatively short wavelength become dominant in place of conventional UV lamps. Even the ArF excimer laser light source, however, is insufficient to meet the requirement for much finer patterns of late. To solve such a problem, though it is conceivable to adopt a light source which emits light of shorter wavelength, e.g., an F2 laser light source, for the exposure apparatus, an immersion exposure method as disclosed in International Publication No. WO 99/49504 in the form of a pamphlet is proposed as an exposure technique which is capable of providing much finer patterns while reducing burdens in cost.

The immersion exposure method is a technique of performing “immersion exposure,” with the space between a projection optical system and a substrate filled with a liquid having a refractive index n (e.g., deionized water with n=1.44) greater than that of the atmosphere (n=1), to increase numerical aperture, thereby improving resolution. This immersion exposure method can provide an equivalent wavelength of 134 nm even if a conventional ArF excimer laser light source (which emits light having a wavelength of 193 nm) is used, to achieve finer patterns of the resist mask while suppressing growing burdens in cost.

Also in such an immersion exposure method, like in a conventional dry exposure process, it is important to precisely align a pattern image of the mask and an exposure area on the substrate with each other. For this reason, also in an exposure apparatus compatible with the immersion exposure method, an alignment process is performed to calibrate the position of a substrate stage and a reticle position to adjust the exposure position of the pattern image. In the exposure apparatus compatible with the immersion exposure process, however, there is apprehension that liquid (liquid for immersion) enters the inside of the substrate stage during the alignment process to cause a trouble. To solve this problem, Japanese Patent Application Laid-Open No. 2005-268747 discloses a technique such that a dummy substrate is placed on the substrate stage for the execution of the alignment process. This prevents the liquid from entering the inside of the stage since the dummy substrate closes a recessed portion of the stage, like in the conventional exposure process.

In the alignment process using the dummy substrate, which is disclosed in Japanese Patent Application Laid-Open No. 2005-268747, if a back surface of the dummy substrate is contaminated, there is a possibility that the contamination may be transferred to the recessed portion of the stage. If the recessed portion of the stage in the exposure apparatus is contaminated by adhesion of particles or the like, this may possibly cause not only adhesion of the particles onto the substrate to be processed but also very small deviation of the vertical position of the substrate during exposure, to cause defocus failure, thereby hindering a precise pattern exposure.

Further, if the stage of the exposure apparatus is contaminated, it becomes necessary to clean the stage itself. It is not easy, however, to clean the stage without stopping the operation of the exposure apparatus.

### SUMMARY OF THE INVENTION

The present invention is intended for a substrate processing apparatus for performing a resist coating process and a development process on a substrate, which is disposed adjacently to an exposure apparatus for performing an exposure process on the substrate.

According to the present invention, the substrate processing apparatus comprises a housing part for housing an exposure apparatus adjustment substrate for use in an adjustment operation in the exposure apparatus, a back surface cleaning part for cleaning a back surface of the exposure apparatus adjustment substrate, a reversing part for reversing upper and lower surfaces of the exposure apparatus adjustment substrate, and a transfer element for passing and receiving the exposure apparatus adjustment substrate to and from the exposure apparatus and for transferring the exposure apparatus adjustment substrate among the housing part, the reversing part and the back surface cleaning part.

This allows the adjustment operation in the exposure apparatus by using the clean exposure apparatus adjustment substrate whose back surface is cleaned in the substrate processing apparatus, and it is thereby possible to reduce the contamination of mechanisms in the exposure apparatus.

Preferably, the substrate processing apparatus further comprises a cleaning controller for controlling the transfer element, the reversing part and the back surface cleaning part to clean the back surface of the exposure apparatus adjustment substrate immediately before or immediately after the adjustment operation in the exposure apparatus.

It is thereby possible to reduce the contamination of the mechanisms in the exposure apparatus with higher reliability.

Preferably, the substrate processing apparatus further comprises a cleaning controller for controlling the transfer element, the reversing part and the back surface cleaning part to periodically clean the back surface of the exposure apparatus adjustment substrate.

It is thereby possible to reduce the contamination of the mechanisms in the exposure apparatus with stability.

The present invention is also intended for a method of processing a substrate, where a substrate after being subjected to a resist coating process in a substrate processing apparatus is transferred to an exposure apparatus, to be subjected to pattern exposure and then transferred back to said substrate processing apparatus, to be subjected to a development process.

Therefore, it is an object of the present invention to provide a substrate processing technique capable of reducing contamination of mechanisms in an exposure apparatus.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a plan view of a substrate processing apparatus in accordance with the present invention;

FIG. 2 is a front view of a liquid processing part of the substrate processing apparatus;

FIG. 3 is a front view of a thermal processing part of the substrate processing apparatus;

FIG. 4 is a view showing a construction around substrate rest parts of the substrate processing apparatus;

FIG. 5A is a plan view of a transfer robot;

FIG. 5B is a front view of the transfer robot;

FIG. 6 is a view for illustrating a construction of a front surface cleaning unit;

FIG. 7 is a view for illustrating a construction of a back surface cleaning unit;

FIG. 8A is a side sectional view of a heating part with a temporary substrate rest part;

FIG. 8B is a plan view of the heating part with the temporary substrate rest part;

FIG. 9 is a side view of an interface block;

FIG. 10 is a perspective view showing a construction of a principal part of a reversing unit;

FIG. 11 is a schematic front view of the reversing unit;

FIG. 12A is a plan view showing a holding arm;

FIG. 12B is a side sectional view showing the holding arm;

FIG. 13 is a schematic view showing a state where the holding arm accesses transfer targets;

FIG. 14 is a schematic block diagram showing a control mechanism for the substrate processing apparatus and an exposure unit;

FIG. 15 is a flowchart showing an exemplary procedure for cleaning of a substrate stage;

FIG. 16 is a flowchart showing another exemplary procedure for cleaning of the substrate stage;

FIG. 17 is a flowchart showing an exemplary procedure for an alignment process in the exposure unit; and

FIG. 18 is a schematic view showing a state where an immersion exposure process is performed on a substrate in the exposure unit.

### DESCRIPTION OF THE PREFERRED EMBODIMENTS

Hereinafter, with reference to the drawings, preferred embodiments of the present invention will be discussed in detail.

### 1. The First Preferred Embodiment

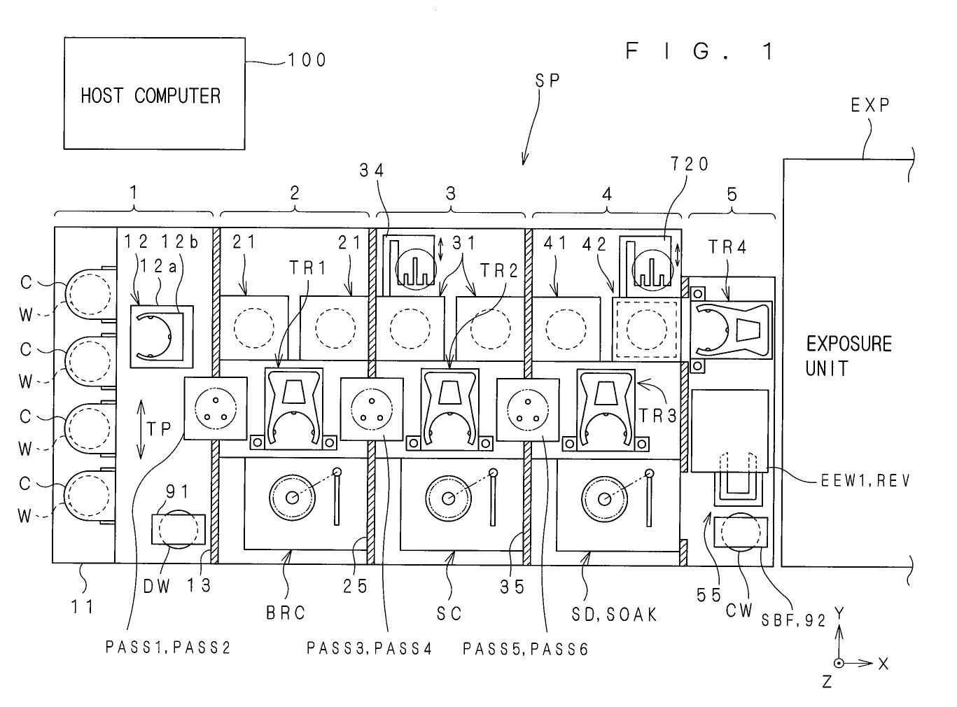

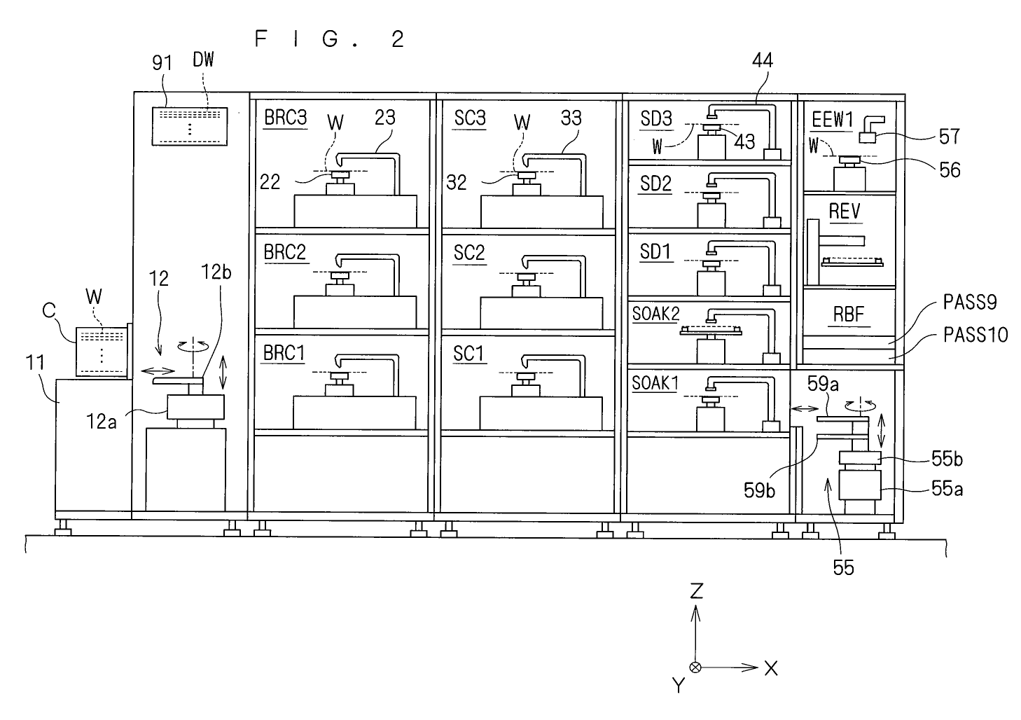

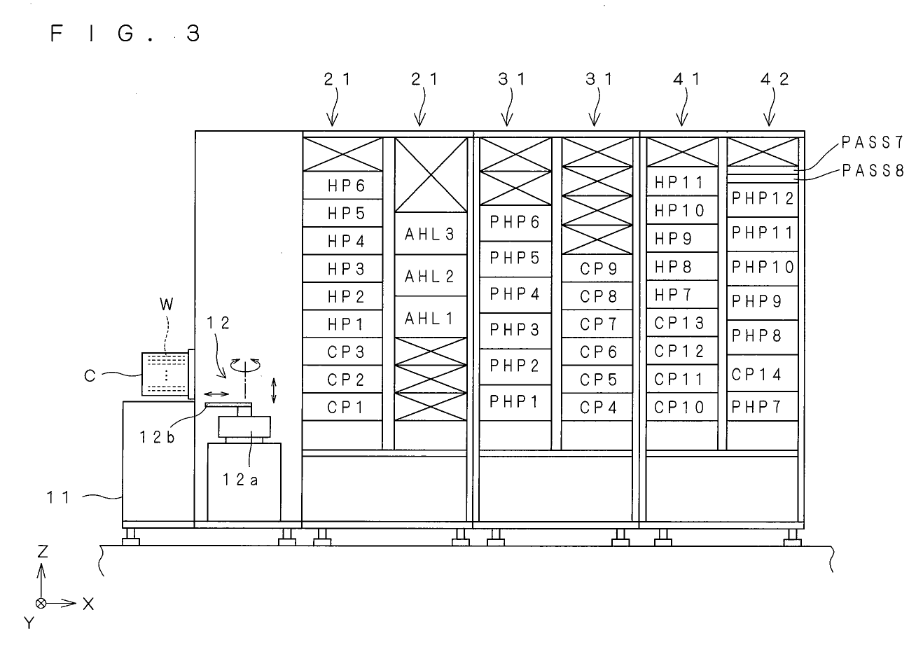

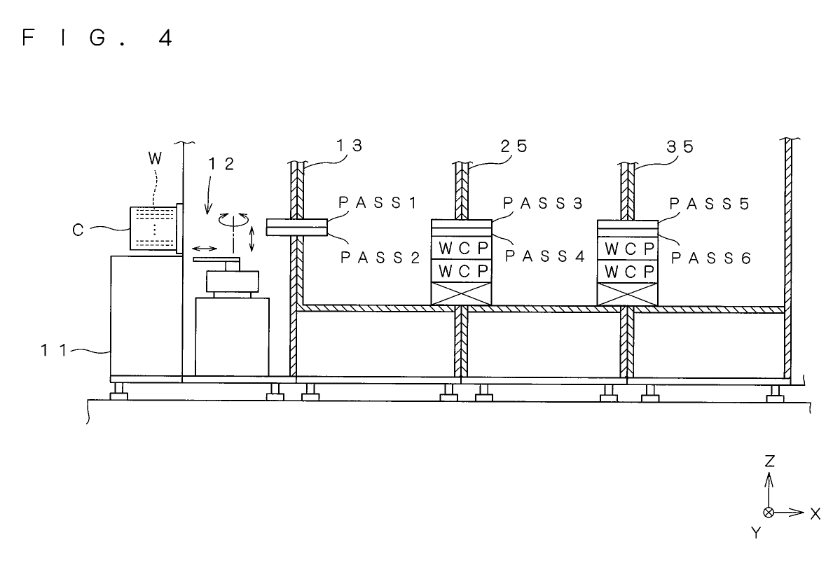

FIG. 1 is a plan view of a substrate processing apparatus in accordance with the present invention. FIG. 2 is a front view of a liquid processing part of the substrate processing apparatus, FIG. 3 is a front view of a thermal processing part of the substrate processing apparatus, and FIG. 4 is a view showing a construction around substrate rest parts. An XYZ rectangular coordinate system in which an XY plane is defined as the horizontal plane and a Z axis is defined to extend in the vertical direction is additionally shown in FIG. 1 and the subsequent figures, as appropriate, for the purpose of clarifying the directional relationship therebetween.

The substrate processing apparatus SP is an apparatus (a so-called coater-and-developer) for forming an anti-reflective film and a photoresist film on substrates such as semiconductor wafers by coating and for performing a development process on the substrates after being subjected to a pattern exposure process. The substrates to be processed by the substrate processing apparatus SP of the present invention are not limited to semiconductor wafers, but may include glass substrates for liquid crystal display devices, and the like.

The substrate processing apparatus SP of a first preferred embodiment consists of five processing blocks which are arranged in side-by-side relation, i.e., an indexer block 1, a BARC (Bottom Anti-Reflective Coating) block 2, a resist coating block 3, a development block 4, and an interface block 5. An exposure unit (or stepper) EXP for performing an exposure process on a resist-coated substrate is connected to the interface block 5. In other words, the substrate processing apparatus SP is disposed adjacently to the exposure unit EXP. The substrate processing apparatus SP and the exposure unit EXP of the first preferred embodiment are connected via LAN lines to a host computer 100.

The indexer block 1 is a processing block for transferring unprocessed substrates received from the outside of the substrate processing apparatus SP to the BARC block 2 and the resist coating block 3, and for transferring processed substrates received from the development block 4 to the outside of the substrate processing apparatus SP. The indexer block 1 includes a rest table 11 for placing thereon a plurality of (in this preferred embodiment, four) carriers C in juxtaposition, and a substrate transfer mechanism 12 for taking an unprocessed substrate W out from each of the carriers C and for storing a processed substrate W into each of the carriers C. The substrate transfer mechanism 12 includes a movable base 12a which is movable horizontally (in the Y direction) along a path TP, and a holding arm 12b mounted on the movable base 12a, for holding a substrate W in a horizontal position. The holding arm 12b is capable of moving upwardly and downwardly (in the Z direction) over the movable base 12a, pivoting within a horizontal plane and moving back and forth in the direction of the pivot radius. Thus, the substrate transfer mechanism 12 can cause the holding arm 12b to gain access to each of the carriers C, thereby taking an unprocessed substrate W out from each carrier C and storing a processed substrate W into each carrier C. The carriers C may be of the following types: an SMIF (Standard Mechanical InterFace) pod, and an OC (Open Cassette) which exposes stored substrates W to the atmosphere, besides a FOUP (Front Opening Unified Pod) which stores substrates W in an enclosed or sealed space.

A dummy substrate housing part 91 for housing a dummy substrate DW is provided over a portion of the path TP along which the substrate transfer mechanism 12 is movable. The dummy substrate housing part 91 has a multi-tier cabinet structure capable of storing a plurality of dummy substrates DW. The dummy substrate DW is used in the immersion-compatible exposure unit EXP to prevent deionized water from entering the inside of a substrate stage during an alignment process for adjusting the exposure position of a pattern image, such as calibrating a stage position and the like. The dummy substrate DW is approximately identical in shape and size with a normal substrate W (for semiconductor device fabrication). The material of the dummy substrate DW may be the same as that of the normal substrate W (e.g., silicon), but has only to prevent contaminants from dissolving out in a liquid during an immersion exposure process. The dummy substrate DW may have a surface with water repellency. An example of the technique for making the surface of the dummy substrate DW water-repellent is a coating process using a water-repellent material such as a fluorine compound, a silicon compound, an acrylic resin, polyethylene and the like. Alternatively, the dummy substrate DW itself may be made of any one of the above-discussed water-repellent materials. When the alignment process is not performed, such as when the normal exposure process is performed, the dummy substrate DW is not needed and therefore is held in the dummy substrate housing part 91 of the indexer block 1. The substrate transfer mechanism 12 takes the dummy substrate DW into and out from the dummy substrate housing part 91. Specifically, the movable base 12a moves along the path TP and the holding arm 12b moves upwardly and downwardly and moves back and forth, whereby the substrate transfer mechanism 12 takes the dummy substrate DW into and out from the dummy substrate housing part 91.

The BARC block 2 is provided in adjacent relation to the indexer block 1. A partition 13 for closing off the communication of atmosphere is provided between the indexer block 1 and the BARC block 2. The partition 13 is provided with a pair of vertically arranged substrate rest parts PASS1 and PASS2 on which a substrate W is placed for the transfer between the indexer block 1 and the BARC block 2.

The upper substrate rest part PASS1 is used for the transfer of a substrate W from the indexer block 1 to the BARC block 2. The substrate rest part PASS1 includes three support pins. The substrate transfer mechanism 12 of the indexer block 1 places an unprocessed substrate W taken out from one of the carriers C onto the three support pins of the substrate rest part PASS1. The substrate transfer mechanism 12 also places the dummy substrate DW taken out from the dummy substrate housing part 91 onto the substrate rest part PASS1. A transfer robot TR1 of the BARC block 2 to be described later receives the substrate W or the dummy substrate DW, which is placed on the substrate rest part PASS1. The lower substrate rest part PASS2, on the other hand, is used for the transfer of a substrate W from the BARC block 2 to the indexer block 1. The substrate rest part PASS2 also includes three support pins. The transfer robot TR1 of the BARC block 2 places a processed substrate W onto the three support pins of the substrate rest part PASS2. The substrate transfer mechanism 12 receives the substrate W placed on the substrate rest part PASS2 and stores the substrate W into one of the carriers C. Pairs of substrate rest parts PASS3 to PASS10 to be described later are similar in construction to the pair of substrate rest parts PASS1 and PASS2.

The substrate rest parts PASS1 and PASS2 extend through part of the partition 13. Each of the substrate rest parts PASS1 and PASS2 includes an optical sensor (not shown) for detecting the presence or absence of a substrate W thereon. Based on a detection signal from each of the sensors, a judgment is made as to whether or not the substrate transfer mechanism 12 and the transfer robot TR1 of the BARC block 2 stand ready to pass and receive a substrate W to and from the substrate rest parts PASS1 and PASS2.

Next, the BARC block 2 will be described. The BARC block 2 is a processing block for forming an anti-reflective film by coating at the bottom of a photoresist film to reduce standing waves or halation occurring during exposure. The BARC block 2 includes a bottom coating processor BRC for coating the surface of a substrate W with the anti-reflective film, a pair of thermal processing towers 21 for performing a thermal process which accompanies the formation of the anti-reflective film by coating, and the transfer robot TR1 for passing and receiving the substrate W to and from the bottom coating processor BRC and the pair of thermal processing towers 21.

In the BARC block 2, the bottom coating processor BRC and the pair of thermal processing towers 21 are arranged on opposite sides of the transfer robot TR1. Specifically, the bottom coating processor BRC is on the front side of the substrate processing apparatus SP, and the pair of thermal processing towers 21 are on the rear side thereof. Additionally, a thermal barrier not shown is provided on the front side of the pair of thermal processing towers 21. Thus, the thermal effect of the pair of thermal processing towers 21 upon the bottom coating processor BRC is avoided by arranging the bottom coating processor BRC apart from the pair of thermal processing towers 21 and by providing the thermal barrier.

As shown in FIG. 2, the bottom coating processor BRC includes three coating units BRC1, BRC2 and BRC3 similar in construction to each other and arranged in stacked relation in bottom-to-top order. The three coating units BRC1, BRC2 and BRC3 are collectively referred to as the bottom coating processor BRC, unless otherwise identified. Each of the coating units BRC1, BRC2 and BRC3 includes a spin chuck 22 for rotating a substrate W in a substantially horizontal plane while holding the substrate W in a substantially horizontal position by adsorption, a coating nozzle 23 for applying a coating solution for the anti-reflective film onto the substrate W held on the spin chuck 22, a spin motor (not shown) for rotatably driving the spin chuck 22, a cup (not shown) surrounding the substrate W held on the spin chuck 22, and the like.

As shown in FIG. 3, one of the thermal processing towers 21 which is closer to the indexer block 1 includes six hot plates HP1 to HP6 for heating a substrate W up to a predetermined temperature, and cool plates CP1 to CP3 for cooling a heated substrate W down to a predetermined temperature and keeping the substrate W at the predetermined temperature. The cool plates CP1 to CP3 and the hot plates HP1 to HP6 are arranged in stacked relation in bottom-to-top order in this thermal processing tower 21. The other of the thermal processing towers 21 which is farther from the indexer block 1 includes three adhesion promotion parts AHL1 to AHL3 arranged in stacked relation in bottom-to-top order for thermally processing a substrate W in a vapor atmosphere of HMDS (hexamethyl disilazane) to promote the adhesion of the resist film to the substrate W. The locations indicated by the cross marks (x) in FIG. 3 are occupied by a piping and wiring section or reserved as empty space for future addition of processing units.

Thus, stacking the coating units BRC1 to BRC3 and the thermal processing units (the hot plates HP1 to HP6, the cool plates CP1 to CP3, and the adhesion promotion parts AHL1 to AHL3 in the BARC block 2) in tiers provides smaller space occupied by the substrate processing apparatus SP to reduce the footprint thereof. The side-by-side arrangement of the pair of thermal processing towers 21 is advantageous in facilitating the maintenance of the thermal processing units and in eliminating the need for extension of ducting and power supply equipment necessary for the thermal processing units to a much higher position.

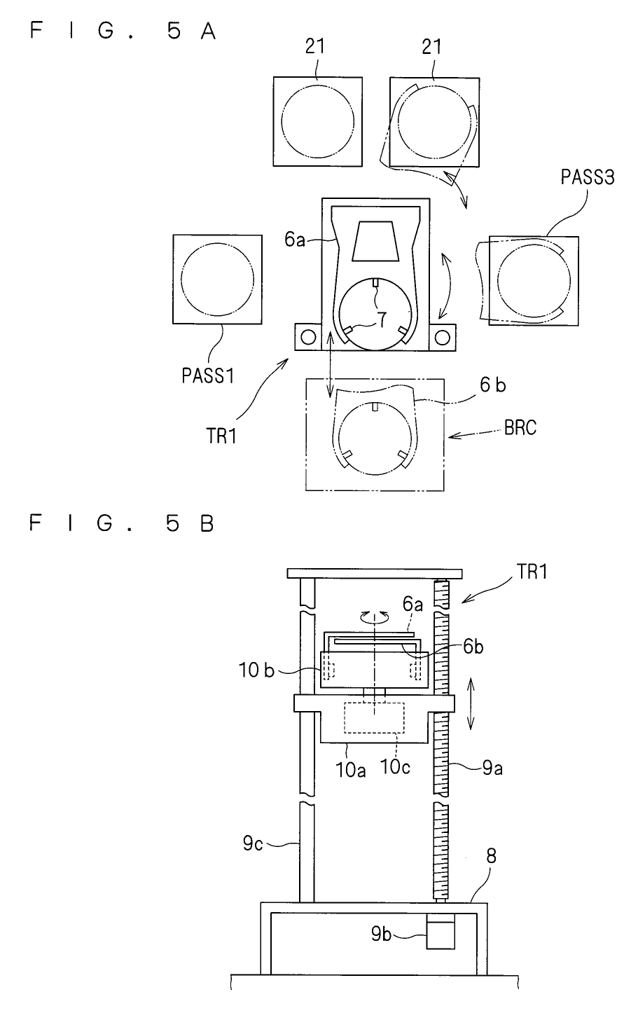

FIGS. 5A and 5B are views for illustrating the transfer robot TR1 provided in the BARC block 2. FIG. 5A is a plan view of the transfer robot TR1, and FIG. 5B is a front view of the transfer robot TR1. The transfer robot TR1 includes a pair of (upper and lower) holding arms 6a and 6b in proximity to each other for holding a substrate W in a substantially horizontal position. Each of the holding arms 6a and 6b includes a distal end portion of a substantially C-shaped plan configuration, and a plurality of pins 7 protruding inwardly from the inside of the substantially C-shaped distal end portion for supporting the peripheral edge of a substrate W from therebeneath.

The transfer robot TR1 further includes a base 8 fixedly mounted on an apparatus base (or an apparatus frame). A guide shaft 9c is mounted upright on the base 8, and a threaded shaft 9a is rotatably mounted and supported upright on the base 8. A motor 9b for rotatably driving the threaded shaft 9a is fixedly mounted to the base 8. An elevation base 10a is in threaded engagement with the threaded shaft 9a, and is freely slidable relative to the guide shaft 9c. With such an arrangement, the motor 9b rotatably drives the threaded shaft 9a, and the elevation base 10a is thereby guided by the guide shaft 9c to move up and down in a vertical direction (in the Z direction).

An arm base 10b is mounted on the elevation base 10a pivotably about a vertical axis. The elevation base 10a contains a motor 10c for pivotably driving the arm base 10b. The pair of (upper and lower) holding arms 6a and 6b described above are vertically provided on the arm base 10b. Each of the holding arms 6a and 6b is independently movable back and forth in a horizontal direction (in the direction of the pivot radius of the arm base 10b) by a slide driving mechanism (not shown) mounted to the arm base 10b.

With such an arrangement, the transfer robot TR1 is capable of causing each of the pair of holding arms 6a and 6b to independently gain access to the substrate rest parts PASS1 and PASS2, the thermal processing units provided in the thermal processing towers 21, the coating units provided in the bottom coating processor BRC, and the substrate rest parts PASS3 and PASS4 described later, thereby passing and receiving substrates W to and from the above-discussed parts and units, as shown in FIG. 5A.

Next, the resist coating block 3 will be described. The resist coating block 3 is provided so as to be sandwiched between the BARC block 2 and the development block 4. A partition 25 for closing off the communication of atmosphere is also provided between the resist coating block 3 and the BARC block 2. The partition 25 is provided with the pair of vertically arranged substrate rest parts PASS3 and PASS4 on which a substrate W is placed for the transfer between the BARC block 2 and the resist coating block 3. The substrate rest parts PASS3 and PASS4 are similar in construction to the above-discussed substrate rest parts PASS1 and PASS2.

The upper substrate rest part PASS3 is used for the transfer of a substrate W from the BARC block 2 to the resist coating block 3. Specifically, a transfer robot TR2 of the resist coating block 3 receives the substrate W which is placed on the substrate rest part PASS3 by the transfer robot TR1 of the BARC block 2. The lower substrate rest part PASS4, on the other hand, is used for the transfer of a substrate W from the resist coating block 3 to the BARC block 2. Specifically, the transfer robot TR1 of the BARC block 2 receives the substrate W which is placed on the substrate rest part PASS4 by the transfer robot TR2 of the resist coating block 3.

The substrate rest parts PASS3 and PASS4 extend through part of the partition 25. Each of the substrate rest parts PASS3 and PASS4 includes an optical sensor (not shown) for detecting the presence or absence of a substrate W thereon. Based on a detection signal from each of the sensors, a judgment is made as to whether or not the transfer robots TR1 and TR2 stand ready to pass and receive a substrate W to and from the substrate rest parts PASS3 and PASS4. A pair of (upper and lower) cool plates WCP of a water-cooling type for roughly cooling a substrate W are vertically provided under the substrate rest parts PASS3 and PASS4, and extend through the partition 25 (See FIG. 4).

The resist coating block 3 is a processing block for applying a resist onto a substrate W which is coated with the anti-reflective film by the BARC block 2 to form a resist film thereon. In the first preferred embodiment, a chemically amplified resist is used as the photoresist. The resist coating block 3 includes a resist coating processor SC for forming the resist film by coating on the anti-reflective film serving as the undercoating film, a pair of thermal processing towers 31 for performing a thermal process which accompanies the resist coating process, and the transfer robot TR2 for passing and receiving a substrate W to and from the resist coating processor SC and the pair of thermal processing towers 31.

In the resist coating block 3, the resist coating processor SC and the pair of thermal processing towers 31 are arranged on opposite sides of the transfer robot TR2. Specifically, the resist coating processor SC is on the front side of the substrate processing apparatus SP, and the pair of thermal processing towers 31 are on the rear side thereof. Additionally, a thermal barrier not shown is provided on the front side of the pair of thermal processing towers 31. Thus, the thermal effect of the pair of thermal processing towers 31 upon the resist coating processor SC is avoided by arranging the resist coating processor SC apart from the pair of thermal processing towers 31 and by providing the thermal barrier.

As shown in FIG. 2, the resist coating processor SC includes three coating units SC1, SC2 and SC3 similar in construction to each other and arranged in stacked relation in bottom-to-top order. The three coating units SC1, SC2 and SC3 are collectively referred to as the resist coating processor SC, unless otherwise identified. Each of the coating units SC 1, SC2 and SC3 includes a spin chuck 32 for rotating a substrate W in a substantially horizontal plane while holding the substrate W in a substantially horizontal position by adsorption, a coating nozzle 33 for applying a resist solution onto the substrate W held on the spin chuck 32, a spin motor (not shown) for rotatably driving the spin chuck 32, a cup (not shown) surrounding the substrate W held on the spin chuck 32, and the like.

As shown in FIG. 3, one of the thermal processing towers 31 which is closer to the indexer block 1 includes six heating parts PHP1 to PHP6 arranged in stacked relation in bottom-to-top order for heating a substrate W up to a predetermined temperature. The other of the thermal processing towers 31 which is farther from the indexer block 1 includes cool plates CP4 to CP9 arranged in stacked relation in bottom-to-top order for cooling a heated substrate W down to a predetermined temperature and keeping the substrate W at the predetermined temperature.

Each of the heating parts PHP1 to PHP6 is a thermal processing unit including, in addition to an ordinary hot plate for heating a substrate W placed thereon, a temporary substrate rest part for placing a substrate W thereon in an upper position spaced apart from the hot plate, and a local transfer mechanism 34 (See FIG. 1) for transferring a substrate W between the hot plate and the temporary substrate rest part. The local transfer mechanism 34 is capable of moving up and down and moving back and forth, and includes a mechanism for cooling down a substrate W being transferred by circulating cooling water therein.

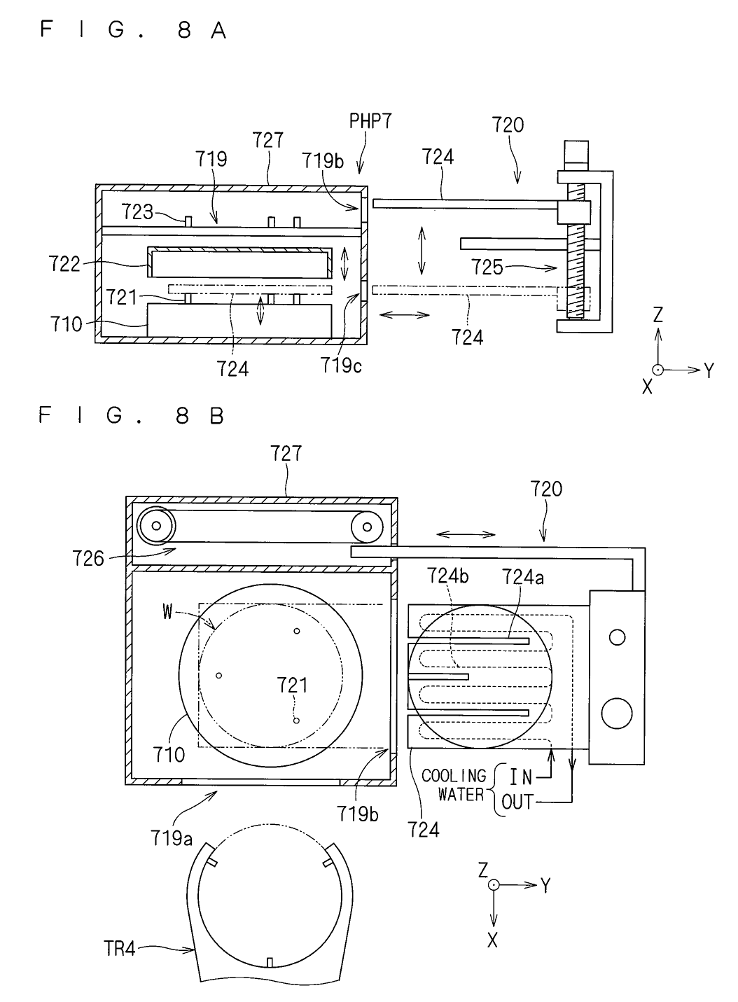

The local transfer mechanism 34 is provided on the opposite side of the above-discussed hot plate and the temporary substrate rest part from the transfer robot TR2, that is, on the rear side of the substrate processing apparatus SP. The temporary substrate rest part has both an open side facing the transfer robot TR2 and an open side facing the local transfer mechanism 34. The hot plate, on the other hand, has only an open side facing the local transfer mechanism 34, and a closed side facing the transfer robot TR2. Therefore, both of the transfer robot TR2 and the local transfer mechanism 34 can gain access to the temporary substrate rest part, but only the local transfer mechanism 34 can gain access to the hot plate. The heating parts PHP1 to PHP6 are generally similar in construction (FIGS. 8A and 8B) to heating parts PHP7 to PHP12 in the development block 4 described later.

A substrate W is transferred into each of the above-discussed heating parts PHP1 to PHP6 having such a construction in a manner to be described below. First, the transfer robot TR2 places a substrate W onto the temporary substrate rest part. Subsequently, the local transfer mechanism 34 receives the substrate W from the temporary substrate rest part and transfers the substrate W to the hot plate. The hot plate performs a heating process on the substrate W. The local transfer mechanism 34 takes out the substrate W after being subjected to the heating process in the hot plate, and transfers the substrate W to the temporary substrate rest part. During the transfer, the substrate W is cooled down by the cooling function of the local transfer mechanism 34. After that, the transfer robot TR2 takes out the substrate W after being subjected to the heating process and transferred to the temporary substrate rest part.

In this manner, the transfer robot TR2 passes and receives the substrate W to and from only the temporary substrate rest part held at room temperature in each of the heating parts PHP1 to PHP6, but does not pass and receive the substrate W directly to and from the hot plate. This avoids the temperature rise of the transfer robot TR2. Since the hot plate has only the open side facing the local transfer mechanism 34, it is possible to prevent the heat atmosphere leaking out from the hot plate from affecting the transfer robot TR2 and the resist coating processor SC. The transfer robot TR2 passes and receives a substrate W directly to and from the cool plates CP4 to CP9.

The transfer robot TR2 is precisely identical in construction with the transfer robot TR1. Therefore, the transfer robot TR2 is capable of causing each of a pair of holding arms thereof to independently gain access to the substrate rest parts PASS3 and PASS4, the thermal processing units provided in the thermal processing towers 31, the coating units provided in the resist coating processor SC, and the substrate rest parts PASS5 and PASS6 described later, thereby passing and receiving substrates W to and from the above-discussed parts and units.

Next, the development block 4 will be described. The development block 4 is provided so as to be sandwiched between the resist coating block 3 and the interface block 5. A partition 35 for closing off the communication of atmosphere is also provided between the resist coating block 3 and the development block 4. The partition 35 is provided with the pair of vertically arranged substrate rest parts PASS5 and PASS6 on which a substrate W is placed for the transfer between the resist coating block 3 and the development block 4. The substrate rest parts PASS5 and PASS6 are similar in construction to the above-discussed substrate rest parts PASS1 and PASS2.

The upper substrate rest part PASS5 is used for the transfer of a substrate W from the resist coating block 3 to the development block 4. Specifically, a transfer robot TR3 of the development block 4 receives the substrate W which is placed on the substrate rest part PASS5 by the transfer robot TR2 of the resist coating block 3. The lower substrate rest part PASS6, on the other hand, is used for the transfer of a substrate W from the development block 4 to the resist coating block 3. Specifically, the transfer robot TR2 of the resist coating block 3 receives the substrate W which is placed on the substrate rest part PASS6 by the transfer robot TR3 of the development block 4.

The substrate rest parts PASS5 and PASS6 extend through part of the partition 35. Each of the substrate rest parts PASS5 and PASS6 includes an optical sensor (not shown) for detecting the presence or absence of a substrate W thereon. Based on a detection signal from each of the sensors, a judgment is made as to whether or not the transfer robots TR2 and TR3 stand ready to pass and receive a substrate W to and from the substrate rest parts PASS5 and PASS6. A pair of (upper and lower) cool plates WCP of a water-cooling type for roughly cooling a substrate W are vertically provided under the substrate rest parts PASS5 and PASS6, and extend through the partition 35 (See FIG. 4).

The development block 4 is a processing block for performing a development process on a substrate W after being subjected to an exposure process. The development block 4 is also capable of cleaning and drying a substrate W after being subjected to an immersion exposure process. The development block 4 includes a development processor SD for applying a developing solution onto a substrate W after pattern exposure to perform the development process, a cleaning processor SOAK for performing a cleaning process and a drying process on a substrate W after being subjected to the immersion exposure process, a pair of thermal processing towers 41 and 42 for performing a thermal process which accompanies the development process, and the transfer robot TR3 for passing and receiving a substrate W to and from the development processor SD, the cleaning processor SOAK and the pair of thermal processing towers 41 and 42. The transfer robot TR3 is precisely identical in construction with the above-discussed transfer robots TR1 and TR2.

As shown in FIG. 2, the development processor SD includes three development units SD1, SD2 and SD3 similar in construction to each other and arranged in stacked relation in bottom-to-top order. The three development units SD 1 to SD3 are collectively referred to as the development processor SD, unless otherwise identified. Each of the development units SD1 to SD3 includes a spin chuck 43 for rotating a substrate W in a substantially horizontal plane while holding the substrate W in a substantially horizontal position by adsorption, a nozzle 44 for applying the developing solution onto the substrate W held on the spin chuck 43, a spin motor (not shown) for rotatably driving the spin chuck 43, a cup (not shown) surrounding the substrate W held on the spin chuck 43, and the like.

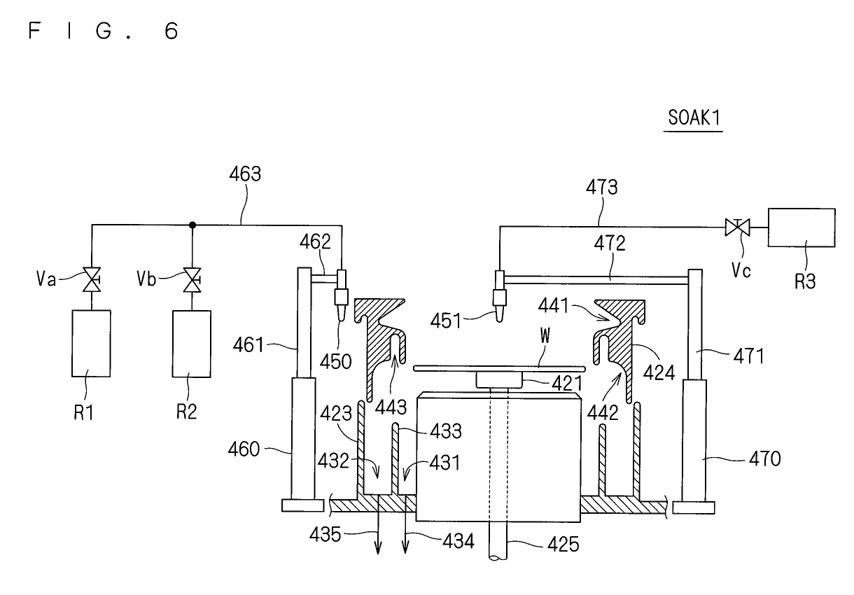

The cleaning processor SOAK includes a front surface cleaning unit SOAK1 and a back surface cleaning unit SOAK2. As shown in FIG. 2, the back surface cleaning unit SOAK2 is disposed above the front surface cleaning unit SOAK1 and the development unit SD1 is disposed above the back surface cleaning unit SOAK2. FIG. 6 is a view for illustrating the construction of the front surface cleaning unit SOAK1. The front surface cleaning unit SOAK1 includes a spin chuck 421 for rotating a substrate W about a vertical rotation axis passing through the center of the substrate W while holding the substrate W in a horizontal position.

The spin chuck 421 is fixed on the upper end of a rotary shaft 425 which is rotated by an electric motor not shown. The spin chuck 421 is provided with a suction passage (not shown). With the substrate W placed on the spin chuck 421, exhausting air from the suction passage allows the lower surface of the substrate W to be vacuum-held on the spin chuck 421, whereby the substrate W is held in a horizontal position.

A first pivoting motor 460 is provided on one side of the spin chuck 421. A first pivoting shaft 461 is connected to the first pivoting motor 460. A first arm 462 is coupled to the first pivoting shaft 461 so as to extend in a horizontal direction, and a cleaning nozzle 450 is provided on a distal end of the first arm 462. The first pivoting motor 460 drives the first pivoting shaft 461 to rotate, thereby pivoting the first arm 462, whereby the cleaning nozzle 450 moves to over the substrate W held by the spin chuck 421.

A tip of a cleaning supply pipe 463 is connected in communication with the cleaning nozzle 450. The cleaning supply pipe 463 is connected in communication with a cleaning liquid supply source R1 and a surface preparation liquid supply source R2 through a valve Va and a valve Vb, respectively. By controlling the opening and closing of the valves Va and Vb, it is possible to select a processing liquid to be supplied to the cleaning supply pipe 463 and adjust the amount of liquid to be supplied. Specifically, a cleaning liquid is supplied to the cleaning supply pipe 463 by opening the valve Va, and a surface preparation liquid is supplied to the cleaning supply pipe 463 by opening the valve Vb.

The cleaning liquid supplied from the cleaning liquid supply source R1 or the surface preparation liquid supplied from the surface preparation liquid supply source R2 is fed through the cleaning supply pipe 463 to the cleaning nozzle 450. This allows the cleaning liquid or the surface preparation liquid to be supplied from the cleaning nozzle 450 to the upper surface of the substrate W. As the cleaning liquid, for example, deionized water, a solution of a complex (ionized) in deionized water and the like may be used. As the surface preparation liquid, for example, hydrofluoric acid and the like may be used. A two-fluid nozzle which mixes droplets into a gas to eject the mixture may be used as the cleaning nozzle 450. As the cleaning nozzle 450, an ultrasonic cleaning nozzle for ejecting a cleaning liquid or a surface preparation liquid which is provided with ultrasound or a high-pressure cleaning nozzle for ejecting a cleaning liquid or the like under high pressure may be used, or another construction may be employed where a brush is used to clean the upper surface of the substrate W while deionized water serving as the cleaning liquid is applied to the surface of the substrate W.

A second pivoting motor 470 is provided on a side of the spin chuck 421 which is different from the above-discussed side. A second pivoting shaft 471 is connected to the second pivoting motor 470. A second arm 472 is coupled to the second pivoting shaft 471 so as to extend in a horizontal direction, and a drying nozzle 451 is provided on a distal end of the second arm 472. The second pivoting motor 470 drives the second pivoting shaft 471 to rotate, thereby pivoting the second arm 472, whereby the drying nozzle 451 moves to over the substrate W held by the spin chuck 421.

A tip of a drying supply pipe 473 is connected in communication with the drying nozzle 451. The drying supply pipe 473 is connected in communication with an inert gas supply source R3 through a valve Vc. By controlling the opening and closing of the valve Vc, it is possible to adjust the amount of inert gas to be supplied to the drying supply pipe 473.

The inert gas supplied from the inert gas supply source R3 is fed through the drying supply pipe 473 to the drying nozzle 451. This allows the inert gas to be supplied from the drying nozzle 451 to the upper surface of the substrate W. As the inert gas, for example, nitrogen gas (N2) and argon gas (Ar) may be used.

When supplying the cleaning liquid or the surface preparation liquid to the upper surface of the substrate W, the cleaning nozzle 450 is positioned over the substrate W held by the spin chuck 421 whereas the drying nozzle 451 is retracted to a predetermined position. When supplying the inert gas to the upper surface of the substrate W, on the other hand, the drying nozzle 451 is positioned over the substrate W held by the spin chuck 421 whereas the cleaning nozzle 450 is retracted to a predetermined position, as shown in FIG. 6.

The substrate W held by the spin chuck 421 is surrounded by a processing cup 423. A cylindrical partition wall 433 is provided inside the processing cup 423. A drainage space 431 for draining the processing liquid (the cleaning liquid or the surface preparation liquid) which has been used for the processing of the substrate W is formed inside the partition wall 433 so as to surround the spin chuck 421. A collected liquid space 432 for collecting the processing liquid which has been used for the processing of the substrate W is formed between the outer wall of the processing cup 423 and the partition wall 433 so as to surround the drainage space 431.

A drainage pipe 434 for guiding the processing liquid to a drainage processing apparatus (not shown) is connected to the drainage space 431, and a collection pipe 435 for guiding the processing liquid to a collection processing apparatus (not shown) is connected to the collected liquid space 432.

A splash guard 424 for preventing the processing liquid from the substrate W from splashing outwardly is provided over the processing cup 423. The splash guard 424 has a configuration rotationally symmetric with respect to the rotary shaft 425. A drainage guide groove 441 of a dog-legged sectional configuration is formed annularly in the inner surface of an upper end portion of the splash guard 424. A collected liquid guide portion 442 defined by an outwardly downwardly inclined surface is formed in the inner surface of a lower end portion of the splash guard 424. A partition wall receiving groove 443 for receiving the partition wall 433 in the processing cup 423 is formed near the upper end of the collected liquid guide portion 442.

The splash guard 424 is driven to move upwardly and downwardly in a vertical direction by a guard elevation driving mechanism (not shown) including a ball screw mechanism and the like. The guard elevation driving mechanism moves the splash guard 424 upwardly and downwardly between a collection position in which the collected liquid guide portion 442 surrounds the edge portion of the substrate W held by the spin chuck 421 and a drainage position in which the drainage guide groove 441 surrounds the edge portion of the substrate W held by the spin chuck 421. When the splash guard 424 is in the collection position (the position shown in FIG. 6), the processing liquid splashed from the edge portion of the substrate W is guided by the collected liquid guide portion 442 into the collected liquid space 432 and then collected through the collection pipe 435. When the splash guard 424 is in the drainage position, on the other hand, the processing liquid splashed from the edge portion of the substrate W is guided by the drainage guide groove 441 into the drainage space 431 and then drained through the drainage pipe 434. In this manner, the drainage and collection of the processing liquid can be selectively carried out. When hydrofluoric acid or the like is used as the surface preparation liquid, strict atmosphere control is required so as to prevent the atmosphere from leaking out within the apparatus.

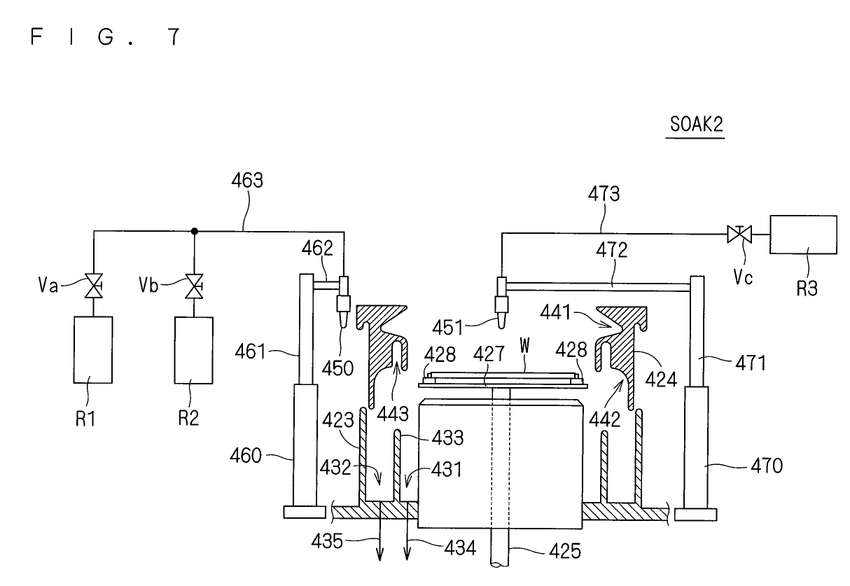

FIG. 7 is a view for illustrating a construction of the back surface cleaning unit SOAK2. The back surface cleaning unit SOAK2 is different from the front surface cleaning unit SOAK1 in shape of a spin chuck 427. The spin chuck 427 of the back surface cleaning unit SOAK2 is used for grasping the edge portions of the substrate W while the spin chuck 421 of the front surface cleaning unit SOAK1 is used for vacuum adsorption of the lower surface of the substrate W. Specifically, a plurality of (in this preferred embodiment, six) support pins 428 stand along one circumference in an upper-surface periphery of the spin chuck 427. Each of the support pins 428 consists of a tubular support portion for supporting a lower-surface periphery of the substrate W from therebeneath and a pin portion which protrudes from the upper surface of the support portion, for coming into contact with the edge portion of the substrate W to press it. Among the six support pins 428, there are three fixed support pins which are fixed on the spin chuck 427. Each of the fixed support pins has a pin portion protruding from the shaft center of the tubular support portion. Among the six support pins 428, on the other hand, the remaining three are movable support pins each of which is provided rotatably about the spin chuck 427. Each of the movable support pins has a pin portion protruding in a slightly eccentric manner from the shaft center of the tubular support portion. The three movable support pins are driven in an interlock manner by a link mechanism and a driving mechanism both of which are not shown, to rotate. Rotation of the movable support pins allows the six pin portions to grasp the edge portions of the substrate W or to release the substrate W. With the six support pins 428 grasping the edge portions of the substrate W, it becomes possible for the spin chuck 427 to hold the substrate W without coming into contact with its lower center.

The remaining constituents of the back surface cleaning unit SOAK2 are the same as the constituents of the front surface cleaning unit SOAK1, and the constituents identical to those of the front surface cleaning unit SOAK1 are represented by the same reference signs as in FIG. 6. Therefore, it is possible for the back surface cleaning unit SOAK2 to supply the cleaning liquid or the surface preparation liquid from the cleaning nozzle 450 and supply the inert gas from the drying nozzle 451 to the upper surface of the substrate W whose edge portions are grasped by the spin chuck 427.

Referring again to FIG. 3, the thermal processing tower 41 which is closer to the indexer block 1 includes five hot plates HP7 to HP11 for heating a substrate W up to a predetermined temperature, and cool plates CP10 to CP13 for cooling a heated substrate W down to a predetermined temperature and for keeping the substrate W at the predetermined temperature. The cool plates CP10 to CP13 and the hot plates HP7 to HP11 are arranged in stacked relation in bottom-to-top order in this thermal processing tower 41.

The thermal processing tower 42 which is farther from the indexer block 1, on the other hand, includes the six heating parts PHP7 to PHP12 and a cool plate CP14 which are arranged in stacked relation. Like the above-discussed heating parts PHP1 to PHP6, each of the heating parts PHP7 to PHP12 is a thermal processing unit including a temporary substrate rest part and a local transfer mechanism.

FIGS. 8A and 8B schematically show the construction of the heating part PHP7 with the temporary substrate rest part. FIG. 8A is a side sectional view of the heating part PHP7, and FIG. 8B is a plan view of the heating part PHP7. Although the heating part PHP7 is shown in FIGS. 8A and 8B, the heating parts PHP8 to PHP12 are precisely identical in construction with the heating part PHP7. The heating part PHP7 includes a heating plate 710 for performing a heating process on a substrate W placed thereon, a temporary substrate rest part 719 for placing a substrate W in an upper or lower position (in this preferred embodiment, an upper position) spaced apart from the heating plate 710, and a local transfer mechanism 720 specific to a thermal processing part, for transferring a substrate W between the heating plate 710 and the temporary substrate rest part 719. The heating plate 710 is provided with a plurality of movable support pins 721 extendable out from and retractable into the plate surface. A vertically movable top cover 722 for covering a substrate W during the heating process is provided over the heating plate 710. The temporary substrate rest part 719 is provided with a plurality of fixed support pins 723 for supporting a substrate W.

The local transfer mechanism 720 includes a holding plate 724 for holding a substrate W in a substantially horizontal position. The holding plate 724 is moved upwardly and downwardly by a screw feed driving mechanism 725, and is moved back and forth by a belt driving mechanism 726. The holding plate 724 is provided with a plurality of slits 724a so as not to interfere with the movable support pins 721 and the fixed support pins 723 when the holding plate 724 moves to over the heating plate 710 and moves into the temporary substrate rest part 719.

The local transfer mechanism 720 further includes a cooling element for cooling a substrate W in the course of the transfer of the substrate W from the heating plate 710 to the temporary substrate rest part 719. As illustrated in FIG. 8B, the cooling element is constructed so that a cooling water passage 724b through which a cooling water flows is provided inside the holding plate 724. The cooling element may be constructed so that, for example, a Peltier device or the like is provided inside the holding plate 724.

The above-discussed local transfer mechanism 720 is provided at the rear of (i.e., on the (+Y) side relative to) the heating plate 710 and the temporary substrate rest part 719 in the substrate processing apparatus SP. A transfer robot TR4 of the interface block 5 is disposed on the (+X) side relative to the heating plate 710 and the temporary substrate rest part 719, and the transfer robot TR3 of the development block 4 is disposed on the (−Y) side relative to the heating plate 710 and the temporary substrate rest part 719. In an upper portion of an enclosure 727 covering the heating plate 710 and the temporary substrate rest part 719, i.e., a portion of the enclosure 727 which covers the temporary substrate rest part 719, an opening 719a is provided on the (+X) side for allowing the transfer robot TR4 to enter the inside of the enclosure 727, and an opening 719b is provided on the (+Y) side for allowing the local transfer mechanism 720 to enter the inside of the enclosure 727. In a lower portion of the enclosure 727, i.e., a portion of the enclosure 727 which covers the heating plate 710, no openings are provided on the (+X) and (−Y) sides (i.e., the surfaces of the enclosure 727 facing the transfer robot TR3 and the transfer robot TR4), and an opening 719c is provided on the (+Y) side for allowing the local transfer mechanism 720 to enter the inside of the enclosure 727.

Loading and unloading of a substrate W to/from the above-discussed heating part PHP7 are performed in such a manner as discussed below. First, the transfer robot TR4 of the interface block 5 holds an exposed substrate W, and places the substrate W onto the fixed support pins 723 of the temporary substrate rest part 719. Subsequently, the holding plate 724 of the local transfer mechanism 720 moves to under the substrate W, and then moves slightly upwardly to receive the substrate W from the fixed support pins 723. The holding plate 724 which holds the substrate W moves backwardly out from the enclosure 727, and then moves downwardly to a position opposed to the heating plate 710. At this time, the movable support pins 721 of the heating plate 710 are in a lowered position, and the top cover 722 is in a raised position. The holding plate 724 which holds the substrate W moves to over the heating plate 710. After the movable support pins 721 move upwardly and receive the substrate W in a receiving position, the holding plate 724 moves backwardly out from the enclosure 727. Subsequently, the movable support pins 721 move downwardly to place the substrate W onto the heating plate 710, and the top cover 722 moves downwardly to cover the substrate W. In this state, the substrate W is subjected to the heating process. After the heating process, the top cover 722 moves upwardly, and the movable support pins 721 move upwardly to lift the substrate W. Next, after the holding plate 724 moves to under the substrate W, the movable support pins 721 move downwardly to pass the substrate W to the holding plate 724. The holding plate 724 which holds the substrate W moves backwardly out from the enclosure 727, and then moves upwardly to transfer the substrate W to the temporary substrate rest part 719. In the course of the transfer, the substrate W supported by the holding plate 724 is cooled by the cooling element of the holding plate 724. The holding plate 724 brings the substrate W which has been cooled (to approximately room temperature) onto the fixed support pins 723 of the temporary substrate rest part 719. The transfer robot TR4 takes out the substrate W and transfers it.

The transfer robot TR4 passes and receives the substrate W to and from only the temporary substrate rest part 719, but does not pass or receive the substrate W to/from the heating plate 710. This avoids the temperature rise of the transfer robot TR4. Further, the opening 719c through which the substrate W is placed onto and removed from the heating plate 710 is formed only on the side of the local transfer mechanism 720. This prevents the heat atmosphere leaking out through the opening 719c from raising the temperatures of the transfer robot TR3 and the transfer robot TR4 and also from affecting the development processor SD and the cleaning processor SOAK.

As discussed above, the transfer robot TR4 of the interface block 5 can gain access to the heating parts PHP7 to PHP12 and the cool plate CP14, but the transfer robot TR3 of the development block 4 cannot gain access thereto. The transfer robot TR3 of the development block 4 gains access to the thermal processing units incorporated in the thermal processing tower 41.

The pair of vertically arranged substrate rest parts PASS7 and PASS8 in proximity to each other for the transfer of a substrate W between the development block 4 and the interface block 5 adjacent thereto are incorporated in the topmost tier of the thermal processing tower 42. The upper substrate rest part PASS7 is used for the transfer of a substrate W from the development block 4 to the interface block 5. Specifically, the transfer robot TR4 of the interface block 5 receives the substrate W which is placed on the substrate rest part PASS7 by the transfer robot TR3 of the development block 4. The lower substrate rest part PASS8, on the other hand, is used for the transfer of a substrate W from the interface block 5 to the development block 4. Specifically, the transfer robot TR3 of the development block 4 receives the substrate W which is placed on the substrate rest part PASS8 by the transfer robot TR4 of the interface block 5. Each of the substrate rest parts PASS7 and PASS8 includes both an open side facing the transfer robot TR3 of the development block 4 and an open side facing the transfer robot TR4 of the interface block 5.

Next, the interface block 5 for connection to the exposure unit EXP will be described. The interface block 5 is a block provided adjacently to the development block 4. The interface block 5 receives a substrate W with the resist film formed thereon by the resist coating process from the resist coating block 3 and transfers the substrate W to the exposure unit EXP. Also, the interface block 5 receives an exposed substrate W from the exposure unit EXP and transfers the exposed substrate W to the development block 4. The interface block 5 of the first preferred embodiment includes a transfer mechanism 55 for passing and receiving a substrate W to and from the exposure unit EXP, an edge exposure unit EEW1 for exposing the periphery of a substrate W with the resist film formed thereon, and the transfer robot TR4 for passing and receiving a substrate W to and from the heating parts PHP7 to PHP12 and the cool plate CP14 provided in the development block 4 and the edge exposure unit EEW1.

As shown in FIG. 2, the edge exposure unit EEW1 includes a spin chuck 56 for rotating a substrate W in a substantially horizontal plane while holding the substrate W in a substantially horizontal position by adsorption, a light irradiator 57 for exposing the periphery of the substrate W held on the spin chuck 56 to light, and the like. The edge exposure unit EEW1 is arranged in the center of the interface block 5. The transfer robot TR4 provided adjacently to the edge exposure unit EEW1 and the thermal processing tower 42 of the development block 4 is similar in construction to the above-discussed transfer robots TR1 to TR3.

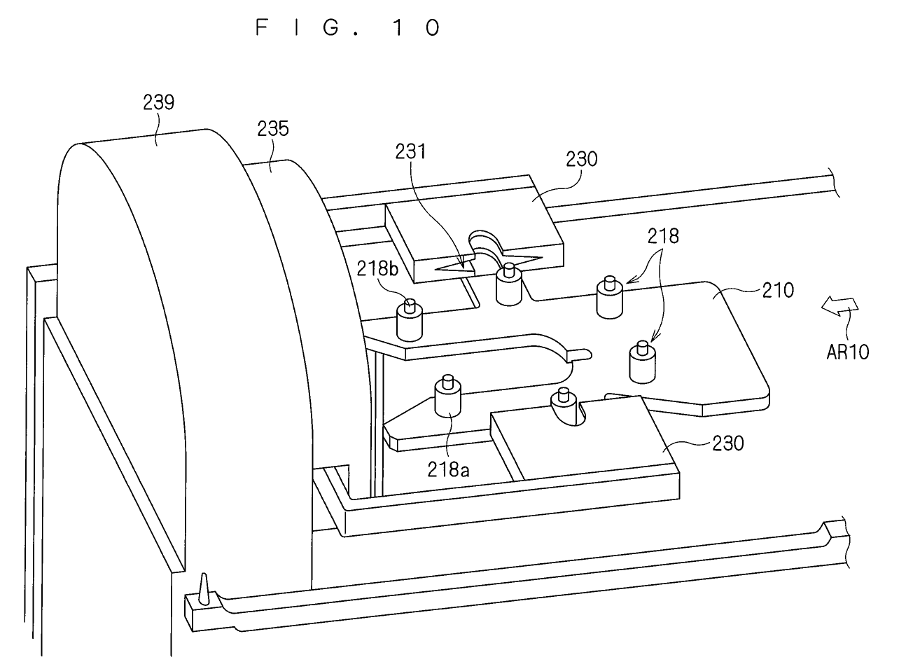

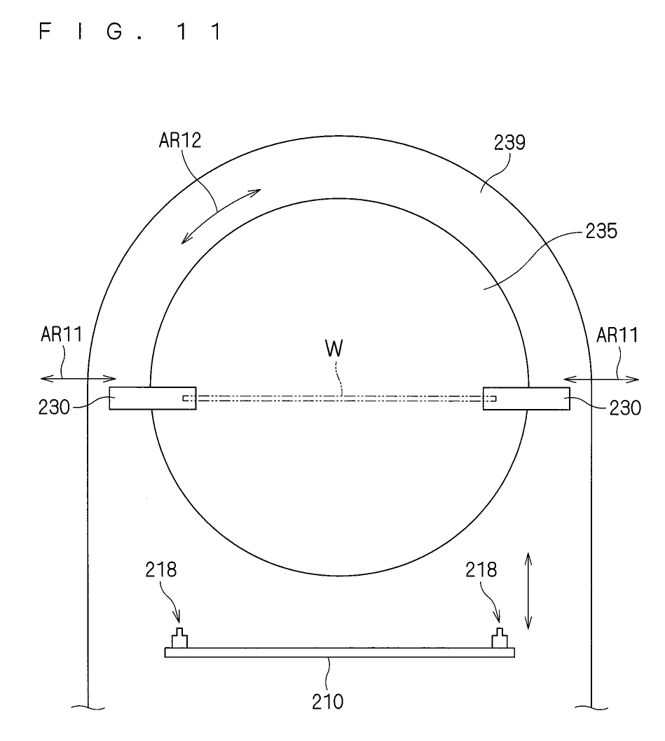

Further, as shown in FIG. 2, a reversing unit REV is provided under the edge exposure unit EEW1. FIG. 10 is a perspective view showing a construction of a principal part of the reversing unit REV. FIG. 11 is a schematic front view of the reversing unit REV as seen from the direction of the arrow AR10 of FIG. 10. The reversing unit REV is a unit for reversing the upper and lower surfaces of the substrate W. The reversing unit REV comprises an elevation table 210 and reversing chucks 230.

The elevation table 210 can be moved upwardly and downwardly along a vertical direction by an elevation driving mechanism which is not shown and includes, e.g., an air cylinder. On the upper surface of the elevation table 210, a plurality of (in this preferred embodiment, six) support pins 218 stand along one circumference. Each of the support pins 218 consists of a support portion 218a for supporting a lower-surface periphery of a substrate W from therebeneath and a pin portion 218b which protrudes from the upper surface of the support portion. The elevation table 210 of the reversing unit REV, unlike the spin chuck 427 of the back surface cleaning unit SOAK2 for rotating the substrate W, does not need so much to firmly hold the substrate W, and therefore all the six support pins 428 are fixed onto the elevation table 210. In other words, the pin portions 218b of the elevation table 210 are members to simply control the horizontal position of the substrate W.

A pair of reversing chucks 230 on the right and left sides are provided along the direction of the radius of a disk-like rotation base 235. The reversing chucks 230 are moved slidingly by a slide driving mechanism incorporated in the rotation base 235 as illustrated by the arrow AR11 of FIG. 11. The pair of reversing chucks 230 slide in an interlock manner to increase or decrease the distance between these chucks. Each of the reversing chucks 230 is provided with a grasping part 231 which is an opening for grasping an edge portion of the substrate W. The two reversing chucks 230 slide so as to decrease their distance in a state where the elevation table 210 holds the substrate W at the same level as the reversing chucks 230, whereby the respective grasping parts 231 can grasp the edge portions of the substrate W. The grasping part 231 is provided with notches to avoid interference with the support pin 218 of the elevation table 210.

The rotation base 235 can be rotated along the direction as illustrated by the arrow AR12 of FIG. 11 in a vertical plane by a rotation driving mechanism provided in a unit base 239. With rotation of the rotation base 235, the pair of reversing chucks 230 rotate along the direction as illustrated by the arrow AR12.

In order for the reversing unit REV to reverse the front and back surfaces of the substrate W, first, the elevation table 210 moves upwardly to a load/unload position at a level higher than the reversing chucks 230. Receiving the substrate W on the support pins 218 from the transfer mechanism 55 described later at the load/unload position, the elevation table 210 moves downwardly to a passing position where it passes the substrate W to the reversing chucks 230. The passing position is a position where the reversing chucks 230 which are still opposingly along the horizontal direction and the substrate W held on the elevation table 210 are in the same level. Further, when the elevation table 210 moves downwardly to the passing position, the reversing chucks 230 have moved so as to make a space which is wide enough for the substrate W to pass therebetween.

In a state where the elevation table 210 is down to the passing position, the pair of reversing chucks 230 start moving slidingly to decrease the distance therebetween and then the respective grasping parts 231 of the reversing chucks 230 come into grasping the edge portions of the substrate W. The substrate W is thereby held by the reversing chucks 230. The elevation table 210 further moves downwardly to an escape position still lower than the passing position. The escape position is a position where the reversing chucks 230 and the elevation table 210 do not collide with each other in the following reversing step.

Next, the rotation base 235 rotates 180 degrees (makes a half turn) to reverse the upper and lower surfaces of the substrate W. After that, the elevation table 210 moves upwardly again from the escape position to the passing position to receive the substrate W onto the support pins 218 and the pair of reversing chucks 230 slidingly move to increase the distance therebetween. Then, receiving the substrate W after being reversed, the elevation table 210 further moves upwardly to the load/unload position and the transfer mechanism 55 receives the reversed substrate W from the support pins 218. Since the support pins 218 serve to support the edge portions of the substrate W, if the front surface of the substrate W which has a pattern thereon becomes a lower surface after the reversing operation, there is no possibility that the support pins 218 might damage the pattern.

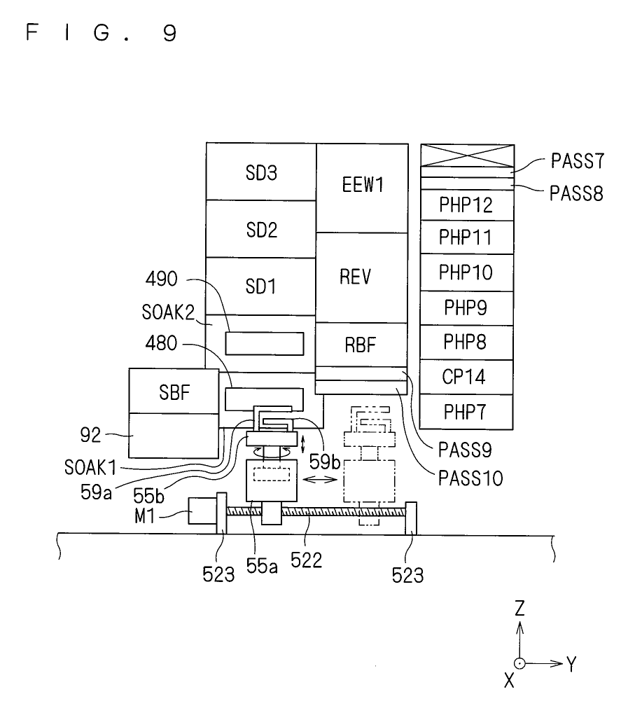

With reference to FIGS. 2 and 9, description on the construction of the interface block 5 will be further continued. FIG. 9 is a side view of the interface block 5 as seen from the (+X) side. The reversing unit REV is provided under the edge exposure unit EEW1, and a return buffer RBF for returning substrates W is provided under the return buffer RBF. The pair of vertically arranged substrate rest parts PASS9 and PASS10 are provided under the return buffer RBF. The return buffer RBF is provided to temporarily store a substrate W after being subjected to a post-exposure bake process in the heating parts PHP7 to PHP12 of the development block 4 if the development block 4 is unable to perform the development process on the substrate W because of some sort of malfunction and the like. The return buffer RBF includes a cabinet capable of storing a plurality of substrates W in tiers. The upper substrate rest part PASS9 is used for passing a substrate W from the transfer robot TR4 to the transfer mechanism 55. The lower substrate rest part PASS10 is used for passing a substrate W from the transfer mechanism 55 to the transfer robot TR4. The transfer robot TR4 gains access to the return buffer RBF.

As shown in FIG. 9, the transfer mechanism 55 includes a movable base 55a in threaded engagement with a threaded shaft 522. The threaded shaft 522 is rotatably supported by a pair of support bases 523 so that the rotation axis thereof should extend along the Y axis. The threaded shaft 522 has one end coupled to a motor M1. The motor M1 drives the threaded shaft 522 to rotate, thereby moving the movable base 55a horizontally along the Y axis.

A hand support base 55b is mounted on the movable base 55a. The hand support base 55b is movable upwardly and downwardly in a vertical direction (along the Z axis) and pivotable about a vertical axis by an elevation mechanism and a pivot mechanism incorporated in the movable base 55a. A pair of holding arms 59a and 59b for holding a substrate W are mounted on the hand support base 55b so as to be arranged vertically. The pair of holding arms 59a and 59b are movable back and forth in the direction of the pivot radius of the hand support base 55b independently of each other by a slide driving mechanism incorporated in the movable base 55a.

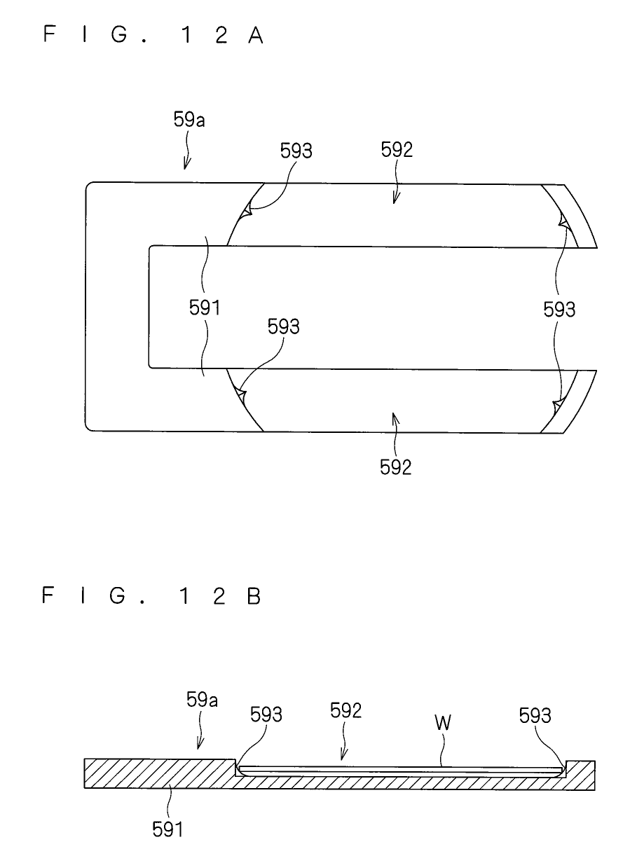

FIGS. 12A and 12B are views showing the holding arms 59a and 59b. FIG. 12A is a plan view showing the holding arm 59a, and FIG. 12B is a side sectional view showing the holding arm 59a. Though description of the holding arm 59a will be presented herein, the description of the lower holding arm 59b is the same as that of the holding arm 59a. The holding arm 59a consists of two arm members 591 which form a fork-like configuration. A recessed portion 592 adaptable to a shape which is slightly larger than the circumference of the substrate W is formed in an upper surface of the arm member 591. Further, both ends of each recessed portion 592 are provided with guide members 593.

The holding arm 59a holds the substrate W so that the substrate W should be fit in the recessed portion 592. At that time, the substrate W is held by four points with its edge portions brought into point contact with the edge lines of the guide members 593. In other words, the holding arm 59a is a low-contact type transfer arm for supporting the edge portions of the substrate W with four points in contact therewith, out of contact with the lower surface of the substrate W. Therefore, even when the transfer mechanism 55 carries the substrate W whose front surface faces down, since the front surface is out of contact with the holding arm 59a, there is no possibility of damaging the pattern and the like formed thereon.

With the above construction, the transfer mechanism 55 serves to pass and receive the substrate W to/from the exposure unit EXP, pass and receive the substrate W to/from the substrate rest parts PASS9 and PASS10, pass and receive the substrate W to/from the reversing unit REV and store the substrate W into or take the substrate W out from a send buffer SBF for sending the substrate W. The send buffer SBF serves to temporarily store the substrate W before exposure when the exposure unit EXP is unable to receive the substrate W and it includes a cabinet capable of storing a plurality of substrates W in tiers.

In the interface block 5, a cleaning substrate housing part 92 for housing a cleaning substrate CW is provided under the send buffer SBF. The cleaning substrate housing part 92 has a multi-tier cabinet structure capable of storing a plurality of cleaning substrates CW. The cleaning substrate CW is used in the immersion-compatible exposure unit EXP to clean a substrate stage. The cleaning substrate CW is approximately identical in shape and size with the normal substrate W (for semiconductor device fabrication). The material of the cleaning substrate CW may be the same as that of the normal substrate W (for example, silicon), but has only to prevent contaminants from dissolving out in the immersion liquid. Like the dummy substrate DW, the cleaning substrate CW may have a surface with water repellency. When the process of cleaning the substrate stage is not performed, such as when the normal exposure process is performed, the cleaning substrate CW is not needed and therefore is held in the cleaning substrate housing part 92. The transfer mechanism 55 takes the cleaning substrate CW into and out from the cleaning substrate housing part 92.

Further, as shown in FIG. 9, the front surface cleaning unit SOAK1 has an opening 480 on its (+X) side and the back surface cleaning unit SOAK2 has an opening 490 on its (+X) side. Therefore, the transfer mechanism 55 is capable of passing and receiving a substrate W to and from both the front surface cleaning unit SOAK1 and the back surface cleaning unit SOAK2 through the openings 480 and 490, respectively.

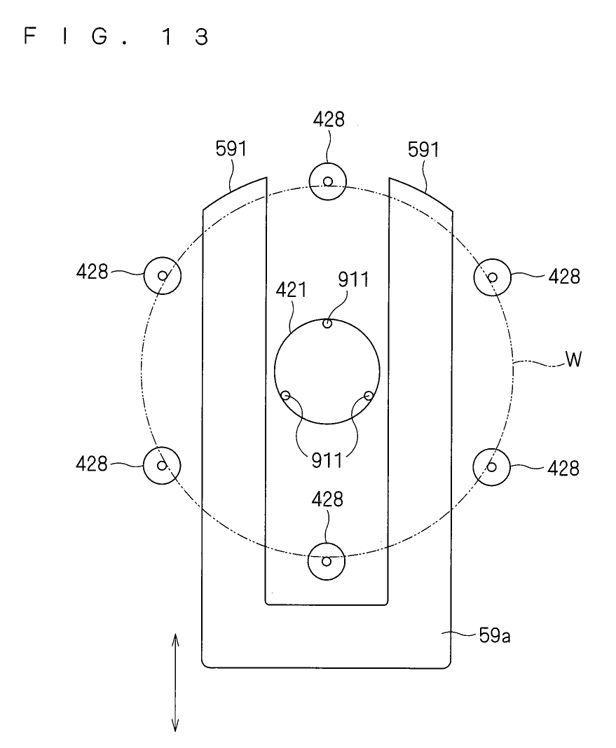

FIG. 13 is a schematic view showing a state where the holding arm 59a accesses transfer targets. Among the targets to and from which the transfer mechanism 55 passes and receives the substrate W, the back surface cleaning unit SOAK2 and the reversing unit REV support the periphery of the substrate W by the support pins 428 and 218, respectively. When the transfer mechanism 55 passes and receives the substrate W to/from the back surface cleaning unit SOAK2, as shown in FIG. 13, the two arm members 591 move back and forth, passing between the support pins 428. The back surface cleaning unit SOAK2 is further provided with a mechanism to stop the spin chuck 427 at a position (the position shown in FIG. 13) where the holding arm 59a entering from the opening 490 and the support pins 428 do not interfere with each other. As this mechanism, for example, a mechanism may be used, which detects the rotation angle of the spin chuck 427 by using an encoder and controls a spin motor so that the spin chuck 427 can stop at a predetermined angle.

The manner in which the transfer mechanism 55 passes and receives the substrate W to/from the reversing unit REV is the same as that for the back surface cleaning unit SOAR2. Since the elevation table 210 of the reversing unit REV does not rotate, however, such a stopping mechanism as the above-discussed encoder is not needed.

On the other hand, the front surface cleaning unit SOAK1 performs vacuum adsorption on the lower surface center of the substrate W by the spin chuck 421. When the transfer mechanism 55 passes and receives the substrate W to/from the front surface cleaning unit SOAK1, as shown in FIG. 13, the holding arm 59a moves back and forth so that the spin chuck 421 should go between the two arm members 591.

Further, the exposure unit EXP has a rest table used for passing and receiving the substrate W to and from the substrate processing apparatus SP, and three support pins 911 for supporting the lower surface center of the substrate W stand on the rest table. The three support pins 911 are disposed within the range of the spin chuck 421 in a plan view. Therefore, when the transfer mechanism 55 passes and receives the substrate W to and from the exposure unit EXP, as shown in FIG. 13, the holding arm 59a moves back and forth so that the three support pins 911 should go between the two arm members 591. The substrate rest parts PASS9 and PASS10, the send buffer SBF and the cleaning substrate housing part 92 each also support the substrate W by three support pins, like the exposure unit EXP, and the transfer mechanism 55 can pass and receive the substrate W to and from these targets in the same manner as to and from the exposure unit EXP.

Thus, the transfer mechanism 55 can pass and receive the substrate W to/from any one of the various transfer targets whose manners of holding the substrate W are different. Though the description of the holding arm 59a has been presented above, as a matter of course, the description of the holding arm 59b is the same as that of the holding arm 59a.

A downflow of clean air is always supplied into the indexer block 1, the BARC block 2, the resist coating block 3, the development block 4 and the interface block 5 described above to thereby avoid the adverse effects of raised particles and gas flows upon the processes in the blocks 1 to 5. Further, a slightly positive pressure relative to the external environment of the substrate processing apparatus SP is maintained in each of the blocks 1 to 5 to prevent entry of particles and contaminants from the external environment into the blocks 1 to 5.

The indexer block 1, the BARC block 2, the resist coating block 3, the development block 4 and the interface block 5 as described above are units into which the substrate processing apparatus SP of this preferred embodiment is divided in mechanical terms. The blocks 1 to 5 are assembled to individual block frames, respectively, which are in turn connected together to construct the substrate processing apparatus SP.

On the other hand, this preferred embodiment employs another type of units, that is, transfer control units regarding the transfer of substrates, aside from the blocks which are units based on the above-discussed mechanical division. The transfer control units regarding the transfer of substrates are referred to herein as “cells.” Each of the cells includes a transfer robot responsible for the transfer of substrates, and a transfer target part to which the transfer robot transfers a substrate. Each of the substrate rest parts described above functions as an entrance substrate rest part for receiving a substrate W into a cell or as an exit substrate rest part for sending a substrate W out from a cell. The transfer of substrates W between the cells is also carried out through the substrate rest parts. The transfer robots which are constituents in the cells include the substrate transfer mechanism 12 of the indexer block 1 and the transfer mechanism 55 of the interface block 5.

The substrate processing apparatus SP of this preferred embodiment includes six cells: an indexer cell, a BARC cell, a resist coating cell, a development cell, a post-exposure bake cell, and an interface cell. The indexer cell includes the rest table 11 and the substrate transfer mechanism 12, and is consequently similar in construction to the indexer block 1 which is one of the units based on the mechanical division. The BARC cell includes the bottom coating processor BRC, the pair of thermal processing towers 21 and the transfer robot TR1. The BARC cell is also consequently similar in construction to the BARC block 2 which is one of the units based on the mechanical division. The resist coating cell includes the resist coating processor SC, the pair of thermal processing towers 31, and the transfer robot TR2. The resist coating cell is also consequently similar in construction to the resist coating block 3 which is one of the units based on the mechanical division. The resist coating cell may be provided with a cover film coating processor for forming a cover film on the resist film so as to prevent the resist from dissolving during exposure.

On the other hand, the development cell includes the development processor SD, the thermal processing tower 41 and the transfer robot TR3. Since the transfer robot TR3 cannot gain access to the heating parts PHP7 to PHP12 or the cool plate CP14 of the thermal processing tower 42 as discussed above, the development cell does not include the thermal processing tower 42. Further, since the transfer mechanism 55 of the interface block 5 gains access to the front surface cleaning unit SOAK1 and the back surface cleaning unit SOAK2 of the cleaning processor SOAK, the cleaning processor SOAK is not also included in the development cell. In these respects, the development cell is different from the development block 4 which is one of the units based on the mechanical division.

The post-exposure bake cell includes the thermal processing tower 42 positioned in the development block 4, the edge exposure unit EEW1 and the transfer robot TR4 which are positioned in the interface block 5. In other words, the post-exposure bake cell extends across the development block 4 and the interface block 5 which are units based on the mechanical division. In this manner, since the heating parts PHP7 to PHP12 for performing the post-exposure bake process and the transfer robot TR4 constitute one cell, the exposed substrates W can be quickly transferred into the heating parts PHP7 to PHP12, to be subjected to the thermal process. It is preferable to adopt such an arrangement in a case of using a chemically amplified resist which needs to be subjected to a heating process as soon as possible after pattern exposure.

The substrate rest parts PASS7 and PASS8 included in the thermal processing tower 42 are provided to transfer a substrate W between the transfer robot TR3 of the development cell and the transfer robot TR4 of the post-exposure bake cell.

The interface cell includes the transfer mechanism 55 for passing and receiving a substrate W to and from the exposure unit EXP, and the cleaning processor SOAK. The interface cell includes the cleaning processor SOAK positioned in the development block 4 and does not include the transfer robot TR4 or the edge exposure unit EEW1, and in these respects, the interface cell is different in construction from the interface block 5 which is one of the units based on the mechanical division. The substrate rest parts PASS9 and PASS10 under the edge exposure unit EEW1 are provided to transfer a substrate W between the transfer robot TR4 of the post-exposure bake cell and the transfer mechanism 55 of the interface cell.

The exposure unit EXP performs the exposure process on a substrate W which is resist-coated in the substrate processing apparatus SP. The exposure unit EXP of this preferred embodiment is an immersion exposure apparatus compatible with an “immersion exposure method” which substantially shortens the wavelength of exposure light to improve resolution and substantially widen the depth of focus. The exposure unit EXP performs the exposure process, with the space between a projection optical system and the substrate W filled with a liquid having a high refractive index (e.g., deionized water having a refractive index n=1.44).

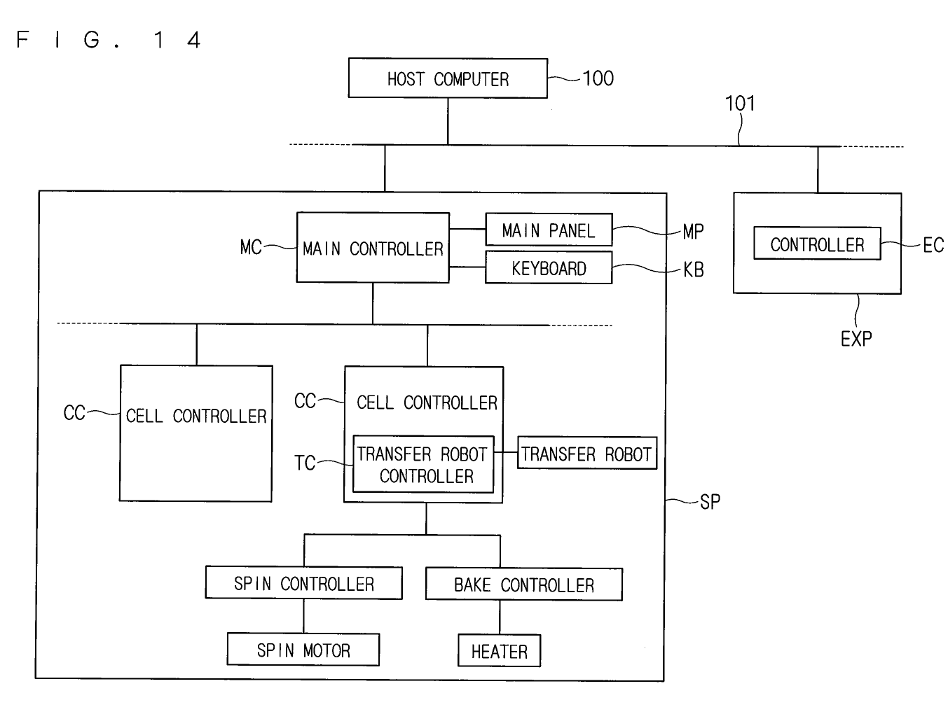

Next, a control mechanism for the substrate processing apparatus SP of the first preferred embodiment will be described. FIG. 14 is a schematic block diagram of a control mechanism for the substrate processing apparatus SP and the exposure unit EXP. As shown in FIG. 14, the substrate processing apparatus SP and the exposure unit EXP are connected to each other through the host computer 100 and a LAN line 101. The substrate processing apparatus SP has a three-level control hierarchy composed of a main controller MC, cell controllers CC, and unit controllers. The main controller MC, the cell controllers CC and the unit controllers are similar in hardware construction to typical computers. Specifically, each of the controllers includes a CPU for performing various computation processes, a ROM or read-only memory for storing a basic program therein, a RAM or readable/writable memory for storing various pieces of information therein, a magnetic disk for storing control applications and data therein, and the like.

The single main controller MC at the first level is provided for the entire substrate processing apparatus SP, and is principally responsible for the management of the entire substrate processing apparatus SP, the management of a main panel MP, and the management of the cell controllers CC. The main panel MP functions as a display for the main controller MC. Various commands and parameters may be entered into the main controller MC from a keyboard KB. The main panel MP may be in the form of a touch panel so that a user can give inputs into the main controller MC from the main panel MP.

The cell controllers CC at the second level are individually provided in corresponding relation to the six cells (the indexer cell, the BARC cell, the resist coating cell, the development cell, the post-exposure bake cell and the interface cell). Each of the cell controllers CC is principally responsible for the control of the transfer of substrates and the management of the units in the corresponding cell. Specifically, the respective cell controllers CC for the cells send and receive information in such a manner that a first cell controller CC for a first cell sends information indicating that a substrate W is placed on a predetermined substrate rest part to a second cell controller CC for a second cell adjacent to the first cell, and the second cell controller CC for the second cell having received the substrate W sends information indicating that the substrate W is received from the predetermined substrate rest part back to the first cell controller CC. Such transmission of information is carried out through the main controller MC. Each of the cell controllers CC gives the information indicating that a substrate W is transferred into the corresponding cell to a transfer robot controller TC, which in turn controls the corresponding transfer robot to circulatingly transfer the substrate W in the corresponding cell in accordance with a predetermined procedure. The transfer robot controller TC is a control part implemented by the operation of a predetermined application in the corresponding cell controller CC.

Examples of the unit controllers at the third level include a spin controller and a bake controller. The spin controller directly controls the spin units (the coating units, the development units and the cleaning unit) provided in a cell in accordance with an instruction given from the corresponding cell controller CC. Specifically, the spin controller controls, for example, a spin motor for a spin unit to adjust the number of revolutions of a substrate W. The bake controller directly controls the thermal processing units (the hot plates, the cool plates, the heating parts and the like) provided in a cell in accordance with an instruction given from the corresponding cell controller CC. Specifically, the bake controller controls, for example, a heater incorporated in a hot plate to adjust a plate temperature and the like.

The exposure unit EXP, on the other hand, is provided with a controller EC which is a separate controller independent of the above-mentioned control mechanism of the substrate processing apparatus SP. In other words, the exposure unit EXP does not operate under the control of the main controller MC of the substrate processing apparatus SP, but controls its own operation alone. The controller EC for the exposure unit EXP is similar in hardware construction to a typical computer. The controller EC controls the exposure process in the exposure unit EXP, and also controls the operation of passing and receiving a substrate to and from the substrate processing apparatus SP.

The host computer 100 ranks as a control mechanism in level higher than the three-level control hierarchy provided in the substrate processing apparatus SP and than the controller EC for the exposure unit EXP. The host computer 100 includes a CPU for performing various computation processes, a ROM or read-only memory for storing a basic program therein, a RAM or readable/writable memory for storing various pieces of information therein, a magnetic disk for storing control applications and data therein and the like, and is similar in construction to a typical computer. Typically, a plurality of substrate processing apparatuses SP and a plurality of exposure units EXP of this preferred embodiment are connected to the host computer 100. The host computer 100 provides a recipe containing descriptions about procedures and processing conditions to each of the substrate processing apparatuses SP and the exposure units EXP connected thereto. The recipe provided from the host computer 100 is stored in a storage part (e.g., a memory) of the main controller MC in each of the substrate processing apparatuses SP and the controller EC in each of the exposure units EXP.

Next, the operation of the substrate processing apparatus SP of this preferred embodiment will be described. First, brief description will be presented on a procedure for the circulating transfer of a normal substrate W in the substrate processing apparatus SP. The procedure described below is executed by the main controller MC giving instructions to the lower-level controllers to control mechanical parts in accordance with the descriptions of the recipe received from the host computer 100.

First, unprocessed substrates W stored in a carrier C are transferred from the outside of the substrate processing apparatus SP into the indexer block 1 by an AGV (Automatic Guided Vehicle) and the like. Subsequently, the unprocessed substrates W are transferred outwardly from the indexer block 1. Specifically, the substrate transfer mechanism 12 in the indexer cell (or the indexer block 1) takes an unprocessed substrate W out from a predetermined carrier C, and places the unprocessed substrate W onto the upper substrate rest part PASS1. After the unprocessed substrate W is placed on the substrate rest part PASS1, the transfer robot TR1 of the BARC cell uses one of the holding arms 6a and 6b to receive the unprocessed substrate W. The transfer robot TR1 transfers the received unprocessed substrate W to one of the coating units BRC1 to BRC3. In the coating units BRC1 to BRC3, the substrate W is spin-coated with the coating solution for the anti-reflective film.

After the completion of the coating process, the transfer robot TR1 transfers the substrate W to one of the hot plates HP1 to HP6. By heating the substrate W in the hot plate, the coating solution on the substrate W is dried to form the anti-reflective film thereon, which serves as the undercoat. After that, by the transfer robot TR1, the substrate W is taken out from the hot plate and transferred to one of the cool plates CP1 to CP3, to be cooled down. In this step, one of the cool plates WCP may be used to cool down the substrate W. The cooled substrate W is placed onto the substrate rest part PASS3 by the transfer robot TR1.

Alternatively, there may be a case where the unprocessed substrate W placed on the substrate rest part PASS1 is transferred to one of the adhesion promotion parts AHL1 to AHL3 by the transfer robot TR1. In the adhesion promotion parts AHL1 to AHL3, the substrate W is thermally processed in a vapor atmosphere of HMDS, whereby the adhesion of the resist film to the substrate W is promoted. By the transfer robot TR1, the substrate W after being subjected to the adhesion promotion process is taken out and transferred to one of the cool plates CP1 to CP3, to be cooled down. Since no anti-reflective film is formed on the substrate W after being subjected to the adhesion promotion process, the cooled substrate W is directly placed onto the substrate rest part PASS3 by the transfer robot TR1.

A dehydration process may be performed prior to the application of the coating solution for the anti-reflective film. In this case, the transfer robot TR1 transfers the unprocessed substrate W placed on the substrate rest part PASS1 first to one of the adhesion promotion parts AHL1 to AHL3. In the adhesion promotion parts AHL1 to AHL3, a heating process (dehydration bake) merely for dehydration is performed on the substrate W without supplying the vapor atmosphere of HMDS. By the transfer robot TR1, the substrate W after being subjected to the heating process for dehydration is taken out and transferred to one of the cool plates CP1 to CP3, to be cooled down. The cooled substrate W is transferred to one of the coating units BRC1 to BRC3 by the transfer robot TR1. In the coating units BRC1 to BRC3, the substrate W is spin-coated with the coating solution for the anti-reflective film. After that, the substrate W is transferred to one of the hot plates HP1 to HP6 by the transfer robot TR1. By heating the substrate W in the hot plate, the anti-reflective film is formed thereon, which serves as the undercoat. Still after that, by the transfer robot TR1, the substrate W is taken out from the hot plate and transferred to one of the cool plates CP1 to CP3, to be cooled down. Then, the cooled substrate W is placed onto the substrate rest part PASS3 by the transfer robot TR1.

After the substrate W is placed onto the substrate rest part PASS3, the transfer robot TR2 of the resist coating cell receives the substrate W to transfer it to one of the coating units SC1 to SC3. In the coating units SC1 to SC3, the substrate W is spin-coated with the resist. Since the resist coating process requires precise substrate temperature control, the substrate W may be transferred to one of the cool plates CP4 to CP9 immediately before being transferred to the coating units SC1 to SC3.

After the completion of the resist coating process, the substrate W is transferred to one of the heating parts PHP1 to PHP6 by the transfer robot TR2. In the heating parts PHP1 to PHP6, by heating the substrate W, a solvent component is removed from the resist and a resist film is formed on the substrate W. After that, by the transfer robot TR2, the substrate W is taken out from the one of the heating parts PHP1 to PHP6 and transferred to one of the cool plates CP4 to CP9, to be cooled down. Then, the cooled substrate W is placed onto the substrate rest part PASS5 by the transfer robot TR2.

After the substrate W with the resist film formed thereon by the resist coating process is placed onto the substrate rest part PASS5, the transfer robot TR3 of the development cell receives the substrate W and places it onto the substrate rest part PASS7 without any processing. Then, the transfer robot TR4 of the post-exposure bake cell receives the substrate W placed on the substrate rest part PASS7 and transfers it into the edge exposure unit EEW1. In the edge exposure unit EEW1, a peripheral edge portion of the substrate W is exposed to light (edge exposure process). After being subjected to edge exposure, the substrate W is placed onto the substrate rest part PASS9 by the transfer robot TR4. The transfer mechanism 55 of the interface cell receives the substrate W placed on the substrate rest part PASS9 and transfers it into the exposure unit EXP. In this step, the transfer mechanism 55 uses the holding arm 59a to transfer the substrate W from the substrate rest part PASS9 into the exposure unit EXP. The resist-coated substrate W which is taken into the exposure unit EXP is subjected to the pattern exposure process.

Since the chemically amplified resist is used in this preferred embodiment, an acid is created in the exposed portion of the resist film formed on the substrate W by a photochemical reaction. In the exposure unit EXP, since the substrate W is subjected to the immersion exposure process, it is possible to achieve a high resolution with virtually no change of the conventional light source or the exposure process. The substrate W after being subjected to the edge exposure process may be transferred by the transfer robot TR4 to the cool plate CP14, to be cooled down, before being transferred into the exposure unit EXP.

By the transfer mechanism 55, the exposed substrate W after being subjected to the pattern exposure process is taken out and returned from the exposure unit EXP to the interface cell again. After that, the exposed substrate W is transferred into the front surface cleaning unit SOAK1 by the transfer mechanism 55. In this step, the transfer mechanism 55 uses the holding arm 59b to transfer the substrate W from the exposure unit EXP to the front surface cleaning unit SOAK1. In some cases, a liquid adheres to the substrate W after being subjected to the immersion exposure process. Since the holding arm 59a is used for the transfer of the unexposed substrate W and the holding arm 59b is exclusively used for the transfer of the exposed substrate W, however, this eliminates at least the possibility that the liquid should adhere to the holding arm 59a, to prevent the liquid from being transferred to the unexposed substrate W.

In the cleaning processing unit SOAK1, the cleaning process is performed by supplying deionized water to the rotating substrate W, and subsequently, the drying process is performed by spraying nitrogen gas onto the substrate W rotating at a high speed. By the transfer mechanism 55, the substrate W after being subjected to the cleaning and drying processes is taken out from the front surface cleaning unit SOAK1 and placed onto the substrate rest part PASS10. In this step, the transfer mechanism 55 uses the holding arm 59a to transfer the substrate W from the front surface cleaning unit SOAK1 to the substrate rest part PASS10. After the exposed substrate W is placed onto the substrate rest part PASS10, the transfer robot TR4 of the post-exposure bake cell receives the substrate W and transfers it to one of the heating parts PHP7 to PHP12. The processing operation in the heating parts PHP7 to PHP12 is as discussed above. In the heating parts PHP7 to PHP12, the heating process (post-exposure bake process) is performed so as to cause a reaction such as crosslinking, polymerization and the like of the resist resin to proceed with a product formed by the photochemical reaction during exposure used as an acid catalyst and thereby locally change the solubility of only an exposed portion of the resist resin to the developing solution. The substrate W after being subjected to the post-exposure bake process is transferred by the local transfer mechanism 720 having the cooling mechanism, to be cooled down, and the above-discussed chemical reaction thereby stops. Subsequently, by the transfer robot TR4, the substrate W is taken out from the one of the heating parts PHP7 to PHP12 and placed onto the substrate rest part PASS8.

After the substrate W is placed onto the substrate rest part PASS8, the transfer robot TR3 of the development cell receives the substrate W and transfers it to one of the cool plates CP10 to CP13. In the cool plates CP10 to CP13, the substrate W after being subjected to the post-exposure bake process is further cooled down and precisely adjusted to a predetermined temperature. After that, the transfer robot TR3 takes the substrate W out from the one of the cool plates CP10 to CP13 and transfers it to one of the development units SD1 to SD3. In the development units SD1 to SD3, the development process proceeds with the developing solution being applied onto the substrate W. After the completion of the development process, by the transfer robot TR3, the substrate W is transferred to one of the hot plates HP7 to HP11 and then transferred to one of the cool plates CP10 to CP13.

After that, the substrate W is placed onto the substrate rest part PASS6 by the transfer robot TR3. The substrate W on the substrate rest part PASS6 is placed onto the substrate rest part PASS4 by the transfer robot TR2 of the resist coating cell without any processing. Further, the substrate W on the substrate rest part PASS4 is placed onto the substrate rest part PASS2 by the transfer robot TR1 of the BARC cell without any processing and is thereby stored in the indexer block 1. Then, the processed substrate W placed on the substrate rest part PASS2 is stored into a predetermined carrier C by the substrate transfer mechanism 12 of the indexer cell. After that, the carrier C in which a predetermined number of processed substrates W are stored is transferred to the outside of the substrate processing apparatus SP. Thus, a series of photolithography processes are completed.

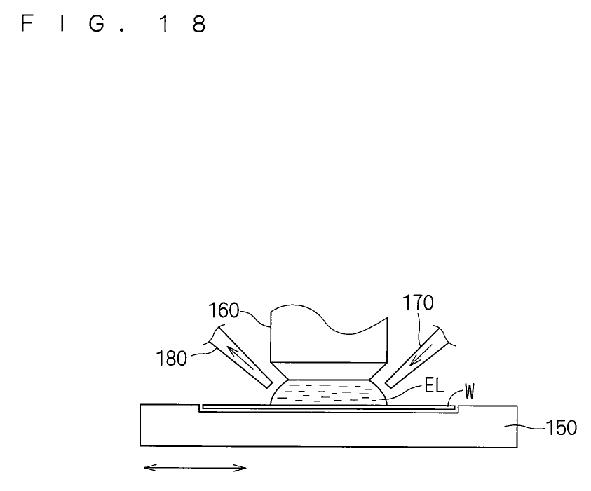

As discussed above, the exposure unit EXP of this preferred embodiment is provided to perform the immersion exposure process. FIG. 18 is a schematic view showing a state where an immersion exposure process is performed on a substrate W in the exposure unit EXP. A substrate stage 150 for holding a substrate W thereon is positioned under a projection optical system 160. An illumination optical system and a mask both not shown are provided over the projection optical system 160. The projection optical system 160 and the mask are slidable in a horizontal plane. While a liquid supply nozzle 170 supplies an immersion liquid (in this preferred embodiment, deionized water) EL onto a substrate W, a liquid collecting nozzle 180 collects the immersion liquid EL. This forms a flow of immersion liquid EL between the projection optical system 160 and the substrate W held on the substrate stage 150, and always fills the gap therebetween with the immersion liquid EL with stability. In such conditions, exposure light is emitted so that a pattern image of the mask is projected through the projection optical system 160 onto the substrate W to expose the substrate W. In this process, the gap between the projection optical system 160 and the substrate W is filled with the immersion liquid EL having a high refractive index (deionized water having a refractive index n=1.44). This substantially shortens the wavelength of the exposure light to improve resolution and to substantially widen the depth of focus.

Further, in the alignment process for adjusting the exposure position of the pattern image, a dummy substrate DW is used to prevent deionized water from entering the inside of the substrate stage 150. Specifically, the dummy substrate DW is transferred from the substrate processing apparatus SP to the exposure unit EXP and fitted into a stage recessed portion of the substrate stage 150 for the execution of the alignment process. This prevents the liquid from entering the inside of the substrate stage 150.

If the stage recessed portion of the substrate stage 150 is contaminated by adhesion of particles or the like, however, this may possibly cause not only transfer of the particles onto the substrate W to contaminate it but also very small deviation of the vertical position of the substrate W during exposure, to cause defocus failure, thereby hindering a precise pattern exposure.

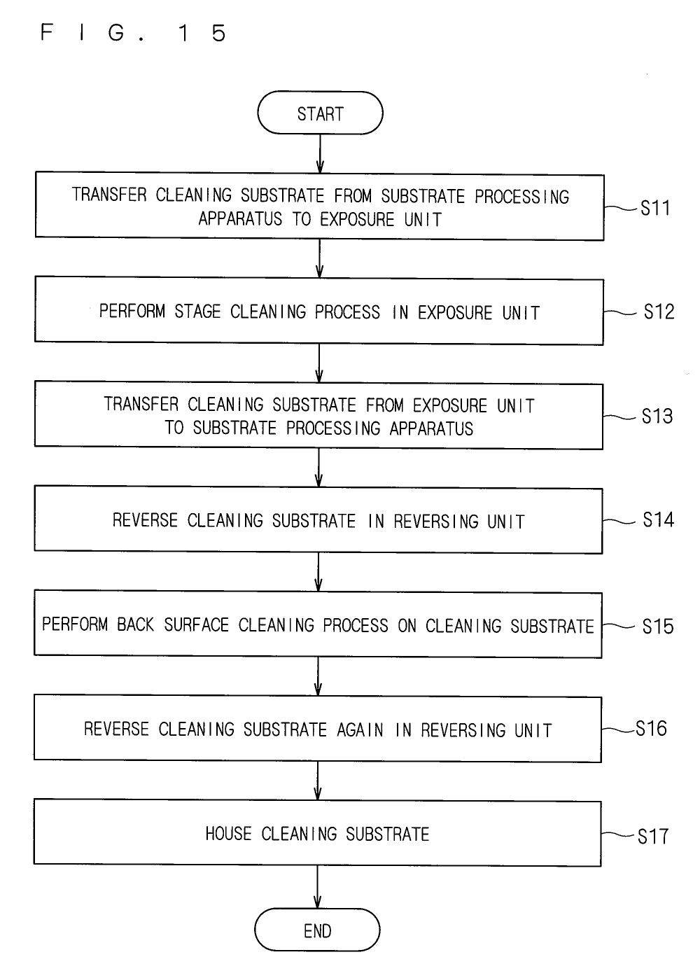

For this reason, in the first preferred embodiment, the substrate stage 150 is cleaned in such a manner as discussed below. FIG. 15 is a flowchart showing an exemplary procedure for cleaning of a substrate stage. This procedure is performed by the main controller MC giving instructions to the lower-level controllers to control the mechanical parts such as the transfer mechanism 55 and the back surface cleaning unit SOAK2.

First, a cleaning substrate CW is transferred from the substrate processing apparatus SP to the exposure unit EXP (in Step S11). Specifically, by the transfer mechanism 55, the cleaning substrate CW is taken out from the cleaning substrate housing part 92 of the interface block 5 and transferred to the exposure unit EXP. The exposure unit EXP fits the cleaning substrate CW received from the substrate processing apparatus SP into the stage recessed portion of the substrate stage 150. By fitting the cleaning substrate CW which is clean into the stage recessed portion of the substrate stage 150, even if some particles or the like adhere to the stage recessed portion, the particles are transferred to the cleaning substrate CW and this consequently cleans the substrate stage 150 (in Step S12). Further, there may be a case where the substrate stage 150 on which the cleaning substrate CW is placed is moved to under the projection optical system 160, and then the liquid supply nozzle 170 supplies deionized water while the liquid collecting nozzle 180 collects the deionized water, whereby a flow of deionized water is formed between the projection optical system 160 and the cleaning substrate CW. In such a manner, it is possible to clean an upper surface of the substrate stage 150 near the surrounding of the cleaning substrate CW.

After the completion of the cleaning process on the substrate stage 150 by using the cleaning substrate CW, the cleaning substrate CW after being used for the cleaning process is transferred from the exposure unit EXP back to the substrate processing apparatus SP (in Step S13). Specifically, the cleaning substrate CW is taken out from the substrate stage 150 in the exposure unit EXP and transferred toward the interface block 5 in the substrate processing apparatus SP. Since the contaminants coming from the substrate stage 150 are adsorbed onto the cleaning substrate CW, especially a back surface thereof, after being used for the cleaning process, it is necessary to wash the contaminants off the cleaning substrate CW.

Herein, a “front surface” of a dummy substrate DW or a cleaning substrate CW refers to a main surface facing upward during the stage cleaning process and the alignment process in the exposure unit EXP. A “back surface” of a dummy substrate DW or a cleaning substrate CW refers to a main surface opposite to the front surface, which is in direct contact with the stage recessed portion during the stage cleaning process and the alignment process. Further, a front surface of a normal substrate W refers to a main surface on which a pattern is formed and a back surface thereof refers to a surface opposite to the front surface. An upper surface (lower surface) of a substrate refers to a surface facing upward (downward) and there are cases where the back surface serves to be an upper surface and where the back surface serves to be a lower surface.

In order to clean the back surface of the cleaning substrate CW, in the substrate processing apparatus SP, the transfer mechanism 55 receives the cleaning substrate CW and transfers it directly to the reversing unit REV, and the reversing unit REV reverses the cleaning substrate CW (in Step S14). The reversing operation in the reversing unit REV is as discussed above, and the cleaning substrate CW is reversed so that its back surface may become an upper surface. Then, the cleaning substrate CW is transferred by the transfer mechanism 55 from the reversing unit REV to the back surface cleaning unit SOAK2, and is subjected to the back surface cleaning process in the back surface cleaning unit SOAK2 (in Step S15).

Herein, a processing operation in the back surface cleaning unit SOAK2 will be described. In the back surface cleaning unit SOAK2, first, for loading of the cleaning substrate CW, the splash guard 424 moves downwardly and the transfer mechanism 55 places the cleaning substrate CW onto the spin chuck 427. Holding the edge portions of the cleaning substrate CW with the six support pins 428, the spin chuck 427 keeps the cleaning substrate CW in a horizontal position with its back surface facing upward.

Next, the splash guard 424 moves to the above-discussed drainage position, and the cleaning nozzle 450 moves to over the center of the cleaning substrate CW. After that, the rotary shaft 425 starts rotating. With rotation of the rotary shaft 425, the cleaning substrate CW held by the spin chuck 427 is rotated. Then, the valve Va is opened to apply the cleaning liquid from the cleaning nozzle 450 onto the upper surface (the back surface, herein) of the cleaning substrate CW. In this preferred embodiment, deionized water is applied as the cleaning liquid to the back surface of the cleaning substrate CW. The back surface cleaning process on the cleaning substrate CW thereby proceeds to wash away particles and the like adhering to the back surface of the cleaning substrate CW. The liquid splashed from the rotating cleaning substrate CW by centrifugal force is guided by the drainage guide groove 441 into the drainage space 431, and is drained through the drainage pipe 434.

After a lapse of a predetermined time, the rotation speed of the rotary shaft 425 decreases. This decreases the amount of deionized water serving as the leaning liquid to be spattered by the rotation of the cleaning substrate CW to form a film of deionized water on the entire back surface of the cleaning substrate CW in such a manner that a puddle of deionized water remains on the cleaning substrate CW. Alternatively, a film of deionized water may be formed on the entire back surface of the cleaning substrate CW by stopping rotation of the rotary shaft 425.

Next, the supply of the deionized water serving as the cleaning liquid is stopped. The cleaning nozzle 450 is retracted to a predetermined position, and the drying nozzle 451 moves to over the center of the cleaning substrate CW. After that, the valve Vc is opened to apply an inert gas from the drying nozzle 451 to near the center of the upper surface of the cleaning substrate CW. In this step, nitrogen gas is discharged as the inert gas. The water or moisture in the center of the back surface of the cleaning substrate CW is thereby forced toward the peripheral edge portion of the cleaning substrate CW. As a result, the film of deionized water remains only in the peripheral edge portion of the back surface of the cleaning substrate CW.

Next, the number of rotation of the rotary shaft 425 increases again, and the drying nozzle 451 gradually moves from over the center of the back surface of the cleaning substrate CW toward over the peripheral edge portion thereof. A great centrifugal force is thereby exerted on the film of deionized water remaining on the back surface of the cleaning substrate CW, and the inert gas can be applied onto the entire back surface of the cleaning substrate CW, whereby the film of deionized water on the cleaning substrate CW can be reliably removed. As a result, the cleaning substrate CW is dried with reliability.

Next, the supply of the inert gas is stopped. The drying nozzle 451 is retracted to a predetermined position, and the rotation of the rotary shaft 425 is stopped. After that, the splash guard 424 moves downwardly and the support pins 428 release the edge portions of the cleaning substrate CW, and the transfer mechanism 55 thereby transfers the cleaning substrate CW outwardly from the back surface cleaning unit SOAK2. This completes the processing operation in the back surface cleaning unit SOAK2. It is preferable that the position of the splash guard 424 during the cleaning and drying processes should be appropriately changed depending on the need for the collection and drainage of the processing liquid.

The cleaning substrate CW after being subjected to the back surface cleaning and drying processes is transferred to the reversing unit REV by the transfer mechanism 55, and reversed therein so that its back surface should face downward (in Step S16). The cleaning substrate CW after being cleaned, which faces originally (so that its back surface should face downward), is transferred by the transfer mechanism 55 back to the cleaning substrate housing part 92, to be housed into its original storage position (in Step S17). This completes the cleaning operation for the substrate stage 150.

In this way, the cleaning substrate CW after being cleaned is always held in the substrate processing apparatus SP, and for the cleaning of the substrate stage 150 in the exposure unit EXP, the cleaning substrate CW received from the substrate processing apparatus SP, being clean, is used. Therefore, it is possible to reduce the contamination of the substrate stage 150. Especially, the back surface of the cleaning substrate CW is kept clean, and by fitting the cleaning substrate CW into the stage recessed portion of the substrate stage 150, some particles or the like adhering to the stage recessed portion are transferred to the back surface of the cleaning substrate CW. It consequently becomes possible to effectively clean the substrate stage 150.

In the first preferred embodiment, the back surface cleaning process on the cleaning substrate CW is performed in the back surface cleaning unit SOAK2 immediately after the cleaning of the substrate stage 150 in the exposure unit EXP, that is, immediately after the back surface of the cleaning substrate CW is contaminated. If the cleaning substrate CW which is contaminated after the cleaning of the substrate stage 150 is left uncleaned, the contaminants would firmly adhere to the cleaning substrate CW. This makes it difficult to remove the contaminants from the cleaning substrate CW in some cases. Further, this also causes contamination of the cleaning substrate housing part 92. As shown in the first preferred embodiment, however, by performing the back surface cleaning process on the cleaning substrate CW immediately after the cleaning of the substrate stage 150, it is possible to remove the contamination from the back surface of the cleaning substrate CW easily with reliability.

### 2. The Second Preferred Embodiment

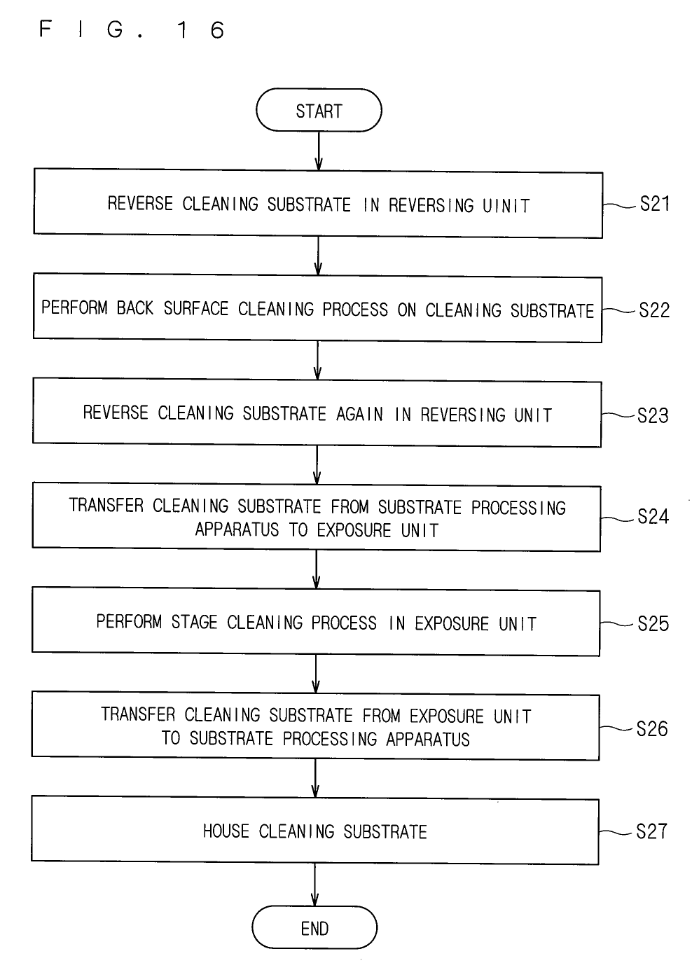

Next, a second preferred embodiment of the present invention will be discussed. The second preferred embodiment is similar to the first preferred embodiment in construction of the substrate processing apparatus SP and the exposure unit EXP and in procedure of processing a normal substrate W. The second preferred embodiment differs from the first preferred embodiment in procedure of cleaning the substrate stage 150. FIG. 16 is a flowchart showing another exemplary procedure for cleaning of the substrate stage.

In the procedure shown in FIG. 16, the transfer mechanism 55 takes the cleaning substrate CW out from the cleaning substrate housing part 92 to transfer it directly to the reversing unit REV, and the reversing unit REV reverses the upper and lower surfaces of the cleaning substrate CW (in Step S21). The reversing operation in the reversing unit REV is as discussed above, and the cleaning substrate CW is reversed so that its back surface may become an upper surface. Then, the cleaning substrate CW is transferred by the transfer mechanism 55 from the reversing unit REV to the back surface cleaning unit SOAK2 and is subjected to the back surface cleaning process in the back surface cleaning unit SOAK2 (in Step S22). The details of the back surface cleaning and drying processes on the cleaning substrate CW in the back surface cleaning unit SOAK2 are the same as those in the first preferred embodiment.

The cleaning substrate CW after being subjected to the back surface cleaning and drying processes is taken out from the back surface cleaning unit SOAK2 and transferred again to the reversing unit REV by the transfer mechanism 55, to be reversed again so that its back surface may become a lower surface (in Step S23). The cleaning substrate CW after being cleaned, which faces originally (so that its back surface should face downward), is transferred to the exposure unit EXP by the transfer mechanism 55 (in Step S24). After that, the cleaning process on the substrate stage 150 by using the cleaning substrate CW is performed in such a manner as in the first preferred embodiment (in Step S25).

After the completion of the cleaning process on the substrate stage 150, the cleaning substrate CW after being used for the cleaning process is transferred from the exposure unit EXP to the substrate processing apparatus SP (in Step S26). In the second preferred embodiment, the transfer mechanism 55 receives the cleaning substrate CW to transfer it directly to the cleaning substrate housing part 92 and houses the cleaning substrate CW into its original storage position (in Step S27).

In the second preferred embodiment, the back surface cleaning process on the cleaning substrate CW is performed immediately before the cleaning of the substrate stage 150 whereas in the first preferred embodiment, the back surface cleaning process on the cleaning substrate CW is performed immediately after the cleaning of the substrate stage 150 in the exposure unit EXP. Though there is apprehension that some particles or the like should adhere to the cleaning substrate CW while the cleaning substrate CW is held in the cleaning substrate housing part 92, when the cleaning process on the cleaning substrate CW is performed immediately before the cleaning of the substrate stage 150 as in the second preferred embodiment, the cleaning of the substrate stage 150 can be performed by using the cleaning substrate CW which is clean, immediately after being cleaned, and it is therefore possible to remove the contamination from the substrate stage 150 with higher reliability. Since the back surface, especially, of the cleaning substrate CW is surely made clean immediately before the cleaning of the substrate stage 150, some particles or the like adhering to the stage recessed portion can be surely transferred to the back surface of the cleaning substrate CW by fitting the cleaning substrate CW into the stage recessed portion of the substrate stage 150, and consequently, it is possible to effectively clean the substrate stage 150.

### 3. The Third Preferred Embodiment

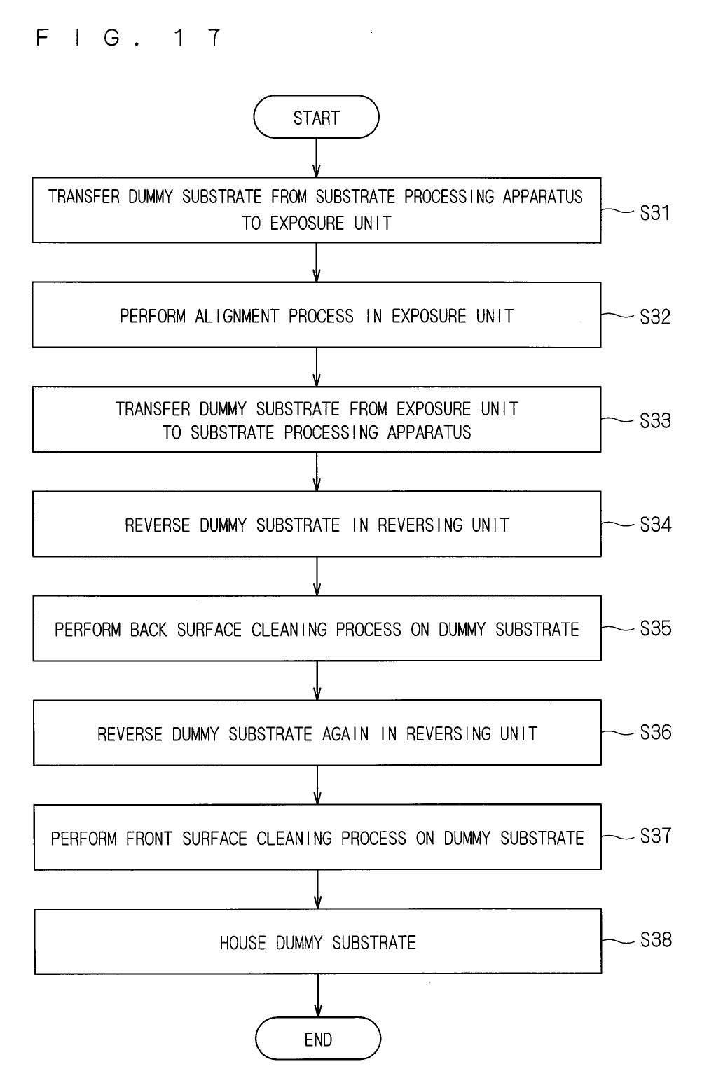

Next, a third preferred embodiment of the present invention will be discussed. The third preferred embodiment is similar to the first preferred embodiment in construction of the substrate processing apparatus SP and the exposure unit EXP and in procedure of processing a normal substrate W. The third preferred embodiment differs from the first preferred embodiment in performing the alignment process using a dummy substrate DW in the exposure unit EXP. FIG. 17 is a flowchart showing an exemplary procedure for the alignment process in the exposure unit EXP.

First, the dummy substrate DW is transferred from the substrate processing apparatus SP to the exposure unit EXP (in Step S31). Specifically, the dummy substrate DW is taken by the substrate transfer mechanism 12 out from the dummy substrate housing part 91 in the indexer block 1, being passed to the transfer robots TR1, TR2, TR3 and TR4 and the transfer mechanism 55 in the interface block 5 in this order, and finally transferred by the transfer mechanism 55 into the exposure unit EXP. During the above-mentioned transfer, the substrate rest parts PASS1, PASS3, PASS5, PASS7 and PASS9 are used. In the exposure unit EXP, the dummy substrate DW received from the substrate processing apparatus SP is placed on the substrate stage 150, and the substrate stage 150 is moved to under the projection optical system 160.

The exposure unit EXP is provided to perform the immersion exposure process, and uses the dummy substrate DW to prevent deionized water from entering the inside of the substrate stage 150 during the alignment process for adjusting the exposure position of the pattern image. Specifically, the dummy substrate DW is fitted into the stage recessed portion of the substrate stage 150 for the execution of the alignment process (in Step S32). This prevents the liquid from entering the inside of the substrate stage 150.

After the completion of the alignment process, the dummy substrate DW after being used for the alignment process is transferred from the exposure unit EXP back to the substrate processing apparatus SP (in Step S33). Specifically, the dummy substrate DW is taken out from the substrate stage 150 in the exposure unit EXP, and is transferred toward the interface block 5 in the substrate processing apparatus SP.

Performing the alignment process using the dummy substrate DW prevents the liquid from entering the inside of the substrate stage 150 but creates a likelihood that the liquid should adhere to the dummy substrate DW to remain in the form of droplets on the dummy substrate DW. If left unremoved, such droplets dry to become a source of contamination. Further, if the back surface of the dummy substrate DW is contaminated, there is a possibility that the contamination may be transferred to the stage recessed portion of the substrate stage 150 during the alignment process.

For this reason, in the substrate processing apparatus SP, the transfer mechanism 55 receives the dummy substrate DW to transfer it directly to the reversing unit REV and the reversing unit REV reverses the upper and lower surfaces of the dummy substrate DW (in Step S34). The reversing operation in the reversing unit REV is the same as that for the cleaning substrate CW discussed above, and the dummy substrate DW is reversed so that its back surface may become an upper surface. Then, the dummy substrate DW is transferred by the transfer mechanism 55 from the reversing unit REV to the back surface cleaning unit SOAK2, and is subjected to the back surface cleaning process in the back surface cleaning unit SOAK2 (in Step S35). The details of the back surface cleaning and drying processes on the dummy substrate DW in the back surface cleaning unit SOAK2 are also the same as those for the cleaning substrate CW in the first and second preferred embodiments.

The dummy substrate DW after being subjected to the back surface cleaning and drying processes is taken out from the back surface cleaning unit SOAK2 and transferred again to the reversing unit REV by the transfer mechanism 55, to be reversed again so that its back surface may become a lower surface (in Step S36). The dummy substrate DW after being reversed again is transferred by the transfer mechanism 55 from the reversing unit REV to the front surface cleaning unit SOAK1, and is subjected to the front surface cleaning process in the front surface cleaning unit SOAK1 (in Step S37).

In the front surface cleaning unit SOAK1, the transfer mechanism 55 places the dummy substrate DW onto the spin chuck 421 for loading of the dummy substrate DW and the spin chuck 421 holds the dummy substrate DW in a horizontal position by adsorption. The cleaning operation in the front surface cleaning unit SOAK1 after that is the same as that in the back surface cleaning unit SOAK2. The front surface cleaning unit SOAK1 performs the front surface cleaning process using the cleaning nozzle 450 and the drying process using the drying nozzle 451 on the front surface of the dummy substrate DW, to thereby clean off the liquid for immersion exposure which adheres to the dummy substrate DW.

The dummy substrate DW after being subjected to the front surface cleaning and drying processes in the front surface cleaning unit SOAK1 is taken out by the transfer mechanism 55, being passed to the transfer robots TR4, TR3, TR2 and TR1 and the substrate transfer mechanism 12 in the indexer block 1 in this order, and finally transferred by the substrate transfer mechanism 12 back to the dummy substrate housing part 91, to be housed into its original storage position (in Step S38). During the above-mentioned transfer, the substrate rest parts PASS10, PASS8, PASS6, PASS4 and PASS2 are used.

In this way, the dummy substrate DW after being cleaned is always held in the substrate processing apparatus SP, and for the alignment process, such as stage position calibration or the like, in the exposure unit EXP, the dummy substrate DW received from the substrate processing apparatus SP, being clean, is used. Therefore, it is possible to reduce the contamination of the substrate stage 150. In the third preferred embodiment, especially, since the back surface of the dummy substrate DW is also kept clean, by performing the alignment process using the dummy substrate DW, it is possible to prevent the transfer of particles to the stage recessed portion of the substrate stage 150 with reliability.

Further, in the third preferred embodiment, the cleaning process on the dummy substrate DW is performed in the substrate processing apparatus SP immediately after the alignment process in the exposure unit EXP, that is, immediately after the dummy substrate DW is contaminated by adhesion of the immersion liquid. If the dummy substrate DW which is contaminated after the alignment process is left uncleaned, the immersion liquid would dry to make the contaminants firmly adhere to the dummy substrate DW. This makes it difficult to remove the contaminants from the dummy substrate DW in some cases. As shown in the third preferred embodiment, however, by performing the cleaning process on the dummy substrate DW immediately after the alignment process, it is possible to remove the contamination from the dummy substrate DW easily with reliability.

When the dummy substrate DW is water-repellent, there are cases where the water repellency of the dummy substrate DW is impaired due to contamination. By removing the contaminants in the above-discussed cleaning process, however, the water repellency of the substrate surface is restored. As a result, with the dummy substrate DW, it is possible to surely hold the immersion liquid also during the alignment process. This also significantly reduces the costs, as compared with the case where dummy substrates DW with less water repellency should be replaced one by one.

In summary of the first to third preferred embodiments, since exposure unit adjustment substrates (the cleaning substrate CW and the dummy substrate DW) for use in the adjustment operations (the cleaning operation for the substrate stage 150 and the alignment operation, respectively) in the exposure unit EXP are held in the substrate processing apparatus SP including the front surface cleaning unit SOAK1 and the back surface cleaning unit SOAK2 and a predetermined adjustment operation can be performed by using a clean exposure unit adjustment substrate in the exposure unit EXP, it is possible to reduce the contamination of the substrate stage 150. By cleaning the back surface of the exposure unit adjustment substrate in the back surface cleaning unit SOAK2, especially, the cleaning operation for the substrate stage 150 or the alignment operation can be performed by using the exposure unit adjustment substrate whose back surface is kept clean, and it is therefore possible to reduce the contamination of the stage recessed portion of the substrate stage 150.

### 4. Variations

While the preferred embodiments of the present invention have been described hereinabove, various changes and modifications other than those described above may be made therein without departing from the spirit of the invention. For example, though the cleaning process on the dummy substrate DW is performed in the substrate processing apparatus SP immediately after the alignment operation in the exposure unit EXP in the above-mentioned third preferred embodiment, the cleaning process on the dummy substrate DW may be performed in the substrate processing apparatus SP immediately before the alignment operation. This allows the alignment operation using the clean dummy substrate DW immediately after being cleaned, to prevent the contamination of the substrate stage 150.

Further, though the front surface cleaning process on the dummy substrate DW is performed after the back surface cleaning process in the third preferred embodiment, the back surface cleaning process may be performed after the front surface cleaning process in reverse order. Specifically, the transfer mechanism 55 receives the dummy substrate DW from the exposure unit EXP and transfers it directly to the front surface cleaning unit SOAK1, and the front surface cleaning process is thereby first performed. Subsequently, the dummy substrate DW is transferred to the reversing unit REV, to be reversed so that its back surface should face upward, and thereafter transferred to the back surface cleaning unit SOAK2, to be subjected to the back surface cleaning process. After that, the dummy substrate DW is transferred to the reversing unit REV again, to be reversed so that its back surface should face downward, and thereafter returned to the dummy substrate housing part 91. Whether the front surface cleaning process or the back surface cleaning process is performed first may be determined depending on the purpose in cleaning the dummy substrate DW. In order to surely clean the back surface of the dummy substrate DW, it is preferable to perform the back surface cleaning process after the front surface cleaning process, and if the cleanness of the front surface is important, it is preferable to perform the front surface cleaning process after the back surface cleaning process.

It is not always necessary to perform both the front surface cleaning process and the back surface cleaning process on the dummy substrate DW, but only either of these cleaning processes may be performed. If only the back surface cleaning process is performed on the dummy substrate DW by using the back surface cleaning unit SOAK2 and the reversing unit REV, since the contamination on at least the back surface is surely cleaned off, it is possible to prevent the stage recessed portion of the substrate stage 150 from being contaminated during the alignment process in the exposure unit EXP. Further, if only either of the front surface cleaning process and the back surface cleaning process is performed, it is possible to cut the time needed for the cleaning process on the dummy substrate DW.

Further, in the first and second preferred embodiments, instead of or in addition to the back surface cleaning process on the cleaning substrate CW, the front surface cleaning process may be performed. The front surface cleaning process on the cleaning substrate CW is performed in the front surface cleaning unit SOAK1, like the front surface cleaning process on the dummy substrate DW. In performing both the front surface cleaning process and the back surface cleaning process on the cleaning substrate CW, either of these processes may be performed first.

Execution of the cleaning process on the cleaning substrate CW is not limited to either immediately before or immediately after the cleaning operation for the substrate stage 150 in the exposure unit EXP, but the back surface cleaning process on the cleaning substrate CW may be performed both immediately before and immediately after the cleaning operation for the substrate stage 150. Similarly, the back surface cleaning process on the dummy substrate DW may be performed both immediately before and immediately after the alignment operation in the exposure unit EXP. It is thereby possible to reduce the contamination of the substrate stage 150 with higher reliability.

The substrate processing apparatus SP may be scheduled in advance to perform the back surface cleaning process on the cleaning substrate CW and/or the dummy substrate DW (the exposure unit adjustment substrate) periodically at predetermined time intervals. Specifically, a module for performing a periodic cleaning of the back surface of the exposure unit adjustment substrate at preset time intervals is included in application software to be executed by the main controller MC of the substrate processing apparatus SP, and the main controller MC which executes the application software causes the transfer mechanism 55, the reversing unit REV, the front surface cleaning unit SOAK1 and the back surface cleaning unit SOAK2 to periodically perform the cleaning process on the exposure unit adjustment substrate. The periodic cleaning of the exposure unit adjustment substrate keeps the surface condition of the exposure unit adjustment substrate always constant with stability, and it consequently becomes possible to reduce the contamination of the mechanisms in the exposure unit EXP with stability.

The timing to periodically perform the cleaning process on the exposure unit adjustment substrate may be set at, for example, regular maintenance of the substrate processing apparatus SP. If the cleaning process on the back surface of the exposure unit adjustment substrate is performed as one of the maintenance processes at the regular maintenance, since there is no apprehension of interference with the processing of normal substrates W, this facilitates the control of the cleaning and transfer. If the cleaning process on the exposure unit adjustment substrate is performed immediately before the adjustment operation (the cleaning operation for the substrate stage 150 or the alignment operation) in the exposure unit EXP, however, the adjustment operation can be performed by using the exposure unit adjustment substrate which is more clean, immediately after being cleaned. If the cleaning process on the exposure unit adjustment substrate is performed immediately after the adjustment operation, it is possible to reliably remove the contamination before the adhered liquid dries. The time intervals at which the periodic cleaning process on the exposure unit adjustment substrate is performed may be inputted from the main panel MP and the keyboard KB to the main controller MC. Alternatively, the host computer 100 may give an instruction to the main controller MC to perform the periodic cleaning process.

Though the front surface cleaning process on the exposure unit adjustment substrate is performed in the front surface cleaning unit SOAK1 and the back surface cleaning process is performed in the back surface cleaning unit SOAK2 in the above-discussed preferred embodiments, both the front surface cleaning process and the back surface cleaning process on the exposure unit adjustment substrate may be performed in the back surface cleaning unit SOAK2. The back surface cleaning unit SOAK2, which holds the edge portions of the exposure unit adjustment substrate with the spin chuck 427, can perform the cleaning process on the exposure unit adjustment substrate even with its back surface facing upward or downward.

In the above-discussed preferred embodiments, the adjustment operation using the exposure unit adjustment substrate may be started by sending an exposure unit adjustment substrate request signal from the controller EC of the exposure unit EXP to the main controller MC of the substrate processing apparatus SP or by sending an adjustment operation start request signal in the opposite direction from the main controller MC to the controller EC. Alternatively, the adjustment operation using the exposure unit adjustment substrate may be started by sending an adjustment operation start signal from the host computer 100 ranking as the higher level controller to the main controller MC and to the controller EC.

Further, there may be a case where a normal substrate W to be processed is reversed in the reversing unit REV and subjected to the back surface cleaning process in the back surface cleaning unit SOAK2. Furthermore, a normal substrate W may be subjected to both the front surface cleaning process and the back surface cleaning process or may be subjected to only either of these cleaning processes. In the case where both the front surface cleaning process and the back surface cleaning process are performed on a normal substrate W, either of these cleaning processes may be performed first. For example, the front surface cleaning process may be performed before the exposure process, and the back surface cleaning process may be performed after the exposure process. Even when the normal substrate W after the exposure process is cleaned in the front surface cleaning unit SOAK1 or the back surface cleaning unit SOAK2, the cleaning operation is performed in the same way as for the above exposure unit adjustment substrate.

Instead of performing the front surface cleaning process on the dummy substrate DW in the front surface cleaning unit SOAK1 or after performing the cleaning process, the surface preparation may be performed by supplying a chemical solution to the dummy substrate DW. The front surface cleaning unit SOAK1 supplies, e.g., hydrofluoric acid as a chemical solution. If the dummy substrate DW is a silicon wafer, like the normal substrate W, a silicon oxide film (a natural oxide film) is formed on the front surface of the dummy substrate DW and the front surface thereby becomes hydrophilic. Supplying hydrofluoric acid as a chemical solution to the front surface of the dummy substrate DW peels the silicon oxide film off to expose a silicon body, and this makes the front surface of the dummy substrate DW water repellent. In summary, supplying the chemical solution imparts (or restores) water repellency to the front surface of the dummy substrate DW. Specifically, while the dummy substrate DW held by the spin chuck 421 is rotated, the valve Vb is opened to feed hydrofluoric acid from the surface preparation liquid supply source R2 to the cleaning nozzle 450 and the cleaning nozzle 450 discharges the hydrofluoric acid onto the front surface of the dummy substrate DW. The chemical solution to be supplied onto the dummy substrate DW is not limited to hydrofluoric acid. There may be a case where a material such as a fluorine compound, an acrylic resin or the like is supplied onto the dummy substrate DW, depending on the material of the dummy substrate DW, and a coating process for imparting water repellency is performed in the front surface cleaning unit SOAK1.

Further, cleaning units designed specifically for cleaning a normal substrate W and an exposure unit adjustment substrate, respectively, may be provided. There may be a case, for example, where the cleaning unit for a normal substrate W is provided in the development block 4 and the cleaning unit for a dummy substrate DW is provided in the interface block 5. In particular, since a substrate W coated with a chemically amplified resist, immediately after being exposed, is highly susceptible to an alkaline atmosphere, if a chemical solution is supplied in a cleaning unit, it is preferable to provide another cleaning unit designed specifically for an exposure unit adjustment substrate.

In the above-mentioned preferred embodiments, the dummy substrate housing part 91 is provided in the indexer block 1 whereas the cleaning substrate housing part 92 is provided in the interface block 5. The present invention, however, is not limited to such an arrangement. The arrangement positions for the dummy substrate housing part 91 and the cleaning substrate housing part 92 may be any positions within the substrate processing apparatus SP. For example, both the dummy substrate housing part 91 and the cleaning substrate housing part 92 may be provided in the indexer block 1. Additionally, both the cleaning substrate CW and the dummy substrate DW may be housed in a single multi-tier substrate housing part.

Though the exposure unit EXP is compatible with the immersion exposure in the above-discussed preferred embodiments, the exposure unit EXP may be of the type which does not use the immersion liquid during the exposure process. Even when the exposure unit EXP is of such dry exposure type, by performing the cleaning of the substrate stage by using the cleaning substrate CW which is clean, after being cleaned in the substrate processing apparatus SP, it is possible to reduce the contamination of the mechanisms in the exposure unit EXP.

The construction of the substrate processing apparatus SP of the present invention is not limited to such as shown in FIGS. 1 to 4. Various modifications, however, may be made to the construction of the substrate processing apparatus SP only if a substrate W is subjected to predetermined processings through a circulating transfer among a plurality of processing parts by using the transfer robots. For example, a cover film coating block for forming a cover film on the resist film may be provided between the resist coating block 3 and the development block 4 to prevent the resist from dissolving during the exposure. A cover film coating processor for forming a cover film on the resist film may be provided in part of the resist coating block 3.

While the invention has been shown and described in detail, the foregoing description is in all aspects illustrative and not restrictive. It is therefore understood that numerous modifications and variations can be devised without departing from the scope of the invention.

What is claimed is:

1. A substrate processing apparatus for performing a resist coating process and a development process on a substrate, said substrate processing apparatus being disposed adjacently to an exposure apparatus for performing an exposure process on the substrate, said substrate processing apparatus comprising:
a housing part for housing an exposure apparatus adjustment substrate for use in an adjustment operation in said exposure apparatus;
a back surface cleaning part for cleaning a back surface of said exposure apparatus adjustment substrate;
a reversing part for reversing upper and lower surfaces of said exposure apparatus adjustment substrate; and
a transfer element for passing and receiving said exposure apparatus adjustment substrate to and from said exposure apparatus and for transferring said exposure apparatus adjustment substrate among said housing part, said reversing part and said back surface cleaning part.

2. The substrate processing apparatus according to claim 1, further comprising
a cleaning controller for controlling said transfer element, said reversing part and said back surface cleaning part to clean the back surface of said exposure apparatus adjustment substrate immediately before or immediately after the adjustment operation in said exposure apparatus.

3. The substrate processing apparatus according to claim 1, further comprising
a cleaning controller for controlling said transfer element, said reversing part and said back surface cleaning part to periodically clean the back surface of said exposure apparatus adjustment substrate.

4. The substrate processing apparatus according to claim 1, further comprising
an indexer part for transferring an unprocessed substrate into said substrate processing apparatus and for transferring a processed substrate out from said substrate processing apparatus,
wherein said housing part is provided in said indexer part.

5. The substrate processing apparatus according to claim 1, further comprising
a front surface cleaning part for cleaning a front surface of said exposure apparatus adjustment substrate,
wherein said transfer element passes and receives said exposure apparatus adjustment substrate to and from said exposure apparatus and transfers said exposure apparatus adjustment substrate among said housing part, said reversing part, said front surface cleaning part and said back surface cleaning part.

6. The substrate processing apparatus according to claim 1, wherein
said exposure apparatus adjustment substrate is an exposure apparatus cleaning substrate to be used for cleaning the inside of said exposure apparatus.

7. The substrate processing apparatus according to claim 1, wherein
said exposure apparatus adjustment substrate is a dummy substrate for use when said exposure apparatus performs an alignment process for adjusting an exposure position.

8. A method of processing a substrate, where a substrate after being subjected to a resist coating process in a substrate processing apparatus is transferred to an exposure apparatus, to be subjected to pattern exposure and then transferred back to said substrate processing apparatus, to be subjected to a development process, said method comprising the steps of:
a) transferring an exposure apparatus adjustment substrate from said substrate processing apparatus to said exposure apparatus, said exposure apparatus adjustment substrate being for use in an adjustment operation in said exposure apparatus;
b) performing the adjustment operation using said exposure apparatus adjustment substrate in said exposure apparatus;
c) transferring said exposure apparatus adjustment substrate after said adjustment operation from said exposure apparatus back to said substrate processing apparatus; and
d) cleaning a back surface of said exposure apparatus adjustment substrate in said substrate processing apparatus.

9. The method according to claim 8, wherein
said step d) is performed immediately before said step a) or immediately after said step c).

10. The method according to claim 8, wherein
said step d) is performed periodically.

11. The method according to claim 8, further comprising the step of
e) cleaning a front surface of said exposure apparatus adjustment substrate in said substrate processing apparatus.

12. The method according to claim 8, wherein
said exposure apparatus adjustment substrate is an exposure apparatus cleaning substrate to be used for cleaning the inside of said exposure apparatus.

13. The method according to claim 8, wherein
said exposure apparatus adjustment substrate is a dummy substrate for use when said exposure apparatus performs an alignment process for adjusting an exposure position.
